(19) United States
(12) Patent Application Publication
(10) Pub. No.: US 2003/0097443 A1
(43) Pub. Date: May 22, 2003

(54) Systems and methods for delivering content over a network

(76) Inventors: Richard Gillett, Westford, MA (US); Daniel Cobb, Shrewsbury, MA (US); Mary Walker, Windham, NH (US); Joseph Amato, Bedford, NH (US); Janet Schank, Merrimack, NH (US)

Correspondence Address: ROPES & GRAY, ONE INTERNATIONAL PLACE, BOSTON, MA, 02110-2624, US

(21) Appl. No.: 09/991,006

(22) Filed: Nov. 21, 2001

(51) Int. Cl. G06F 15/173; G06F 17/30; G06F 7/00; G06F 15/16

(52) U.S. Cl. 709/225; 707/10; 709/219

(57) ABSTRACT

The systems and methods described herein include systems and methods for serving data including streams of content, such as video content, audio content, and other types of content, and for serving the data at a selected level of service. The server provides a flexible platform that can examine an incoming request for content and based on certain attributes associated with that request, make a determination of the level of service that the request is to receive and a determination of whether the system currently has the capacity to handle the request at that level of service. Additionally and optionally, the server allows a network service provider/administrator to determine which attributes are relevant in determining the proper level of service and what level of service, or characteristics of that level of service will be associated with the attribute. To control the processing of requests so that different requests are kept on schedule and that established levels of service are met, the server can include an application program that manages the server processes access to a system resource, such as processor time, network bandwidth/access, disk access, or some other resource.

### FIELD OF THE INVENTION

The invention relates to systems and methods for delivering content over a data network, and more particularly to systems and methods for reliably serving content at a predefined service level.

### BACKGROUND OF THE INVENTION

Today, the growth of computer network systems and in particular the Internet has made it possible to deliver all types of content to businesses, consumers, students and other entities. Additionally, engineers have developed new technologies for delivering data content over data networks. These new technologies include streaming technologies, push technologies and other types of technologies that often put more demands on the data network but provide a different, and often desirable, user experience.

Accordingly, today there exists a large data networking industry that reaches millions of people and carries all kinds of information in many different formats. Along with the growth of this industry, there has been a growing demand for technologies and services that allow network service users to select the level of service they want to receive, with an understanding that the level of service they receive will be related to the cost of that service. For example a business that wishes to deliver a business critical presentation over the data network may demand one level of service and be willing to pay a relatively high value for that high level of service. In contrast, a home user may be interested in receiving certain entertainment content, but the level of service required by the home user for the entertainment and the amount that user is willing to pay may be substantially lower than the amount the business is willing to pay for a business critical presentation. Similarly, users may be willing to pay one price for one type of content, and a second different price for another type of content. Accordingly, as the data networking industry has grown, so too has the consumer demand for price differentiated products and services.

Many of these new differentiated services will be based on the delivery of digital information from a computer system (server) over a network to a user. Unfortunately, there are very few servers capable of distinguishing what type of service level to provide to a user based on who the user is, the interest of the user, the type of content the user wishes to receive, and other factors. As such, the network service providers currently supporting the data networking industry are at a loss to meet this growing consumer demand. Attempts to provide different levels of service have led to network service providers dedicating server systems to each level of service. However, the increased capital and operational costs of dedicated servers may significantly reduce the profit derived from new services. Even if the demand is sufficient to support these dedicated server systems, the network service provider lacks tools sufficient to monitor and coordinate these independent systems to assure that downstream resources do not become a bottleneck where lower priority traffic (from one set of servers) prevents the timely delivery of higher priority traffic (from another set of servers). In addition, a solution consisting of servers dedicated to service levels cannot respond well to changes in demand. In addition, it is a complex process to extract and process information needed to properly bill for services delivered at multiple service levels.

Enterprises are also starting to deploy edge servers in order to offer new services that only practical when content can be served on their LAN and not over their WAN. The impracticality may be economic (WAN bandwidth costs too much) or technological (WAN bandwidth is too low). In either case, enterprises would value a solution which could provide cost effective storage and delivery on each of their LANs. One key to cost effective storage and delivery is the ability to store and serve different data types, including real-time video and audio, http web objects of all sizes, and files of all sizes, from a single server box. Unfortunately, due to limitations in today's server system software there is typically a one-to-one correspondence between server and application (a cache box for cache content, a file server for file content, and a streaming server for streaming media content). This multiplication of boxes prevents widespread deployment of edge storage and delivery.

Accordingly, there is a need in the art for systems and technologies that can support multiple storage and delivery applications on a single server box, for example caching, streaming and filing.

Accordingly, there is a need in the art for systems and technologies that can automatically manage the utilization of resources by different applications based on pre-defined service levels.

Accordingly, there is a need in the art for systems and technologies that can readily provide different levels of service to users based on different factors.

Additionally, there is a need in the art for systems that make it facile to determine service charges for users and content providers that are requesting or offering content according to price differentiated models.

There is a further need in the art for systems that can support multiple levels of service and, specifically, that can schedule a plurality of responses, wherein each response may require a different level of service.

There is yet another need for systems that can allow the level of service provided to a request to vary according to attributes associated with the request, including, but to be limited to, attributes that relate to the content requested, the resources employed to service the request, and the user making the request.

There is still a further need for systems that allow content owners to easily configure the level or levels of service that will be provided to that owner's content.

There is still a further need for systems that can guarantee that a request serviced by the system will be serviced according to an agreed level of service.

Further, there is a need in the art for systems that can provide flexible control of the level of service provided to a request for content and provide such flexible service with systems that include general purpose applications and operating systems.

Still further, there is a need for a system that allows an application developer to develop or modify applications for handling content by allowing the application to interact with the system to adjust or select a level of service to provide a request.

Still further, there is a need in the art for systems that can improve the efficiency of systems that serve content to a user.

Still further, there is a need in the art for systems that enable platforms comprised of unmodified applications and unmodified operating systems to simultaneously deliver content at multiple service levels and to quickly respond to changes in the service level mix.

### SUMMARY OF THE INVENTION

The systems and methods described herein include systems and methods for serving data including streams of content, such as video content, audio content, and other types of content, and for serving the data at a selected level of service. The server provides a flexible platform that can examine an incoming request for content and based on certain attributes associated with that request, make a determination of the level of service that the request is to receive and a determination of whether the system currently has the capacity to handle the request at that level of service. Additionally and optionally, the server allows a network service provider/administrator to determine which attributes are relevant in determining the proper level of service and what level of service, or characteristics of that level of service will be associated with the attribute. To control the processing of requests so that different requests are kept on schedule and that established levels of service are met, the server can include an application program that manages the server processes access to a system resource, such as processor time, network bandwidth/access, disk access, or some other resource.

More particularly, the systems and methods described herein include systems for delivering content over a data network. In one embodiment, these systems may comprise a data storage device for storing content to be delivered over the data network, a server process capable of monitoring the data network for responding to a request to serve selected content over the data network, and a file system capable of processing the request to identify attributes, or meta-data, associated and being representative of a level of service to be provided the selected content.

The system may further include a service level manager capable of determining, as a function of the meta-data, whether the selected content may be serviced in compliance with the associated level of service. The service level manager may process other meta-data as well when making this determination. For example, the service level manager may identify meta-data representative of the user that requested the content, and/or representative of the application that is to be employed to support the request. The meta-data processed may include, but would not be limited to, meta-data selected from the group consisting of user identification, user ISP identification, transmission throughput, client, CDN server identification, and other information about the path that the request took to reach the system.

Still further optionally, the service level manager may include a process for directing the server process to employ a selected file open process for requesting the file system to access data, including meta-data, associated with the selected content. The file open process may have access to a plurality of file open methods, and the method selected may indicate to the file system the level of service to provide the requested content. Alternatively, the file system may include a process for associating with a file open request information that is representative of a level of service to provide to content associated with a request.

In other embodiments, the system further includes a service level manager at the front end of the server process for processing the request, to associate with the request a level of service to provide. Optionally, the service level manager may have a process for inserting information into the pathname associated with the selected content, and the information may be representative of a level of service to provide to the requested content. The file system may include a parsing process for parsing the pathname associated with the selected content to identify a level of service to provide to the requested content.

Further, the system may include a scheduling process for generating a schedule for servicing the requested content. The scheduling process may determine a deadline parameter representative of a time constraint for processing the request, the deadline being calculated based on a service level associated with the request for that file open. Additionally, the scheduling process may determine the deadline parameter as a function of a target bit-rate for serving the selected content.

Further optionally, the system may include a slack-time process for scheduling requests having different service level.

Still further, the system may include a control process for managing a system resource for controlling a rate at which services are provided. The control process may manage any suitable system resource, including those selected from the group consisting of data storage, disk access, system memory, processor resources, and network throughput.

In another aspect, the invention may be understood as methods for serving streams of content at selected levels of service. These methods may include the operations of listening on a data network for a request for a stream of selected content, executing a process capable of identifying a file associated with the selected content and capable of identifying meta-data associated with the file and having information representative of one of a plurality of levels of service to provide a stream of the selected content, and controlling access by a streaming server process to a system resource employed for processing the request as a function of the level of service associated with the selected content.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts schematically a data network employing a system as described herein;

FIG. 2 depicts in more detail one system capable of serving content at a reliable level of service;

FIG. 3 depicts a plurality of nodes mounted into a rack and organized into a cluster;

FIG. 4 depicts an embodiment having a service level manager for comparing available resources with the resource demands of an incoming request;

FIG. 5 depicts an alternative embodiment having a service level manager and a modified application program for comparing available resources with the resource demands of an incoming request;

FIG. 6 depicts another alternative embodiment having an insertion process and a parsing service for associating a service level with the content file and having a service level manager for comparing available resources with the resource demands of an incoming request;

FIG. 7 depicts a flowchart diagram of one process that provides end to end service level performance;

FIG. 8 depicts one example of a resource schedule for determining the availability system resources;

FIG. 9 depicts one example of a resource schedule for determining the availability of system resources when scheduling requests at different levels of service;

FIG. 10 depicts one example of a scheduling procedure for scheduling requests of lower priority during available periods within a schedule plan;

FIG. 11 depicts a screen shot of an account configuration selected by a user;

FIG. 12 depicts a directory organization for the user account depicted in FIG. 11;

FIG. 13 depicts generally one process for assigning a service level to a request for content;

FIG. 14 depicts a functional block diagram of a process for resolving a service-level for an incoming request for content;

FIG. 15 depicts an example of a table structure for storing information representative of different levels of service and characteristics of these different levels of service;

FIG. 16 depicts a table that provides a set of precedence rules for resolving a level of service when multiple service options are available;

FIGS. 17-21 depict several examples of processes for resolving a request to a level of service; and

FIG. 22—depicts an example of the system handling a mixed service level workload

### DESCRIPTION OF THE ILLUSTRATED EMBODIMENTS

To provide an overall understanding of the invention, certain illustrative embodiments will now be described, including a system that may be positioned at the edge of a network for storing and serving data over the network. In particular, the systems and methods described herein include systems and methods that are well suited to serving streams of content, including video content, audio content and other types of content, and for providing those streams of content at a selected level of service. The systems are also capable of intermixing streams of content with static content and other forms of data while maintaining agreed upon levels of service for the data being served.

To illustrate the invention, certain exemplary embodiments will be presented including a server system that includes a network interface for listening on the data network to identify requests for the server to stream selected content. The server also includes a file system, or other application, that can identify meta-data associated with the request and having information that is representative of a level of service to provide when serving the selected content. As the server is connected to a data network, the server can receive a plurality of requests, all of which may be, but are not necessarily, for different content, and all of which are to be processed. To this end, the server may include an application that generates a schedule for servicing the plurality of requests, wherein the schedule takes into consideration the different levels of service associated with the different selections of content. For example, the generated schedule can service requests for content associated with a high level of service before requests for content that are associated with a low or medium level of service. To control the processing of the requests so that different requests are kept on schedule, the server can include an application program that manages the server processes access to a system resource, such as processor time, network bandwidth/access, disk access, or some other resource.

These systems can be realized as rack mounted servers, and in one particular, although not limiting, embodiment, may be realized as rack mounted servers. The server may be an independent computer system or may be formed into a cluster by interconnecting multiple computer systems (nodes). The cluster acts like a single server with increased capacity and availability. Each server may act as a node of the cluster and may include a data processing platform that supports execution of a high-performance web server. The server may further include data storage devices of the type commonly employed for storing data. A file system executing on the server may access data on the data storage devices. In the cluster embodiment, this file system supports shared access across the cluster to provide access to data distributed across the plurality of nodes. Additionally, the shared file system may distribute, manage and store both the data and meta-data that is associated with the data. The meta-data may include, among other things, one or more service level parameters that indicate the level of service that the associated data is to receive when being served to a user. In one embodiment, the service level parameters may be monitored to ensure that data read from the disk is read at a rate which satisfies the desired service level.

Although the below-described systems arise from the subject matter described herein, these systems are not presented as an exhaustive inventory of all the systems and methods that may be achieved. Thus, it is to be understood by those of ordinary skill in the art that the systems and methods described herein may be adapted and modified for other applications and that such adaptations and modifications will not depart from the scope hereof.

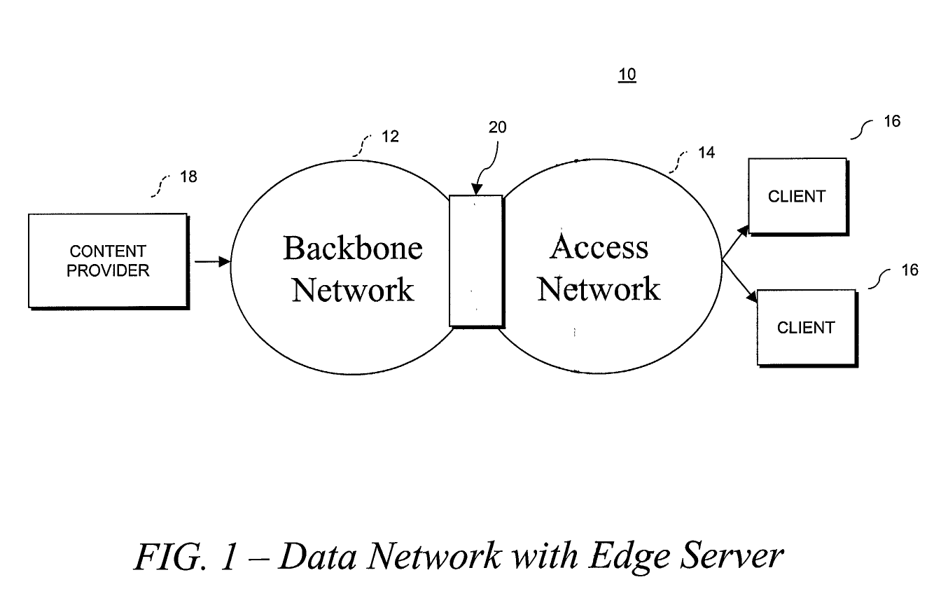

Turning now to certain example systems, FIG. 1 depicts a network system 10 that comprises a backbone network 12 and an access network 14. FIG. 1 shows two clients 16 coupled to the access network 14 and a content provider 18 that couples to backbone 12. At the intersection of the backbone network 12 and the access network 14 an edge server system 20 is disposed. The depicted edge server system 20 operates as an edge server that may store and serve data, such as multi-media content, that was earlier delivered over the backbone network 12 and subsequently stored within the edge server system 20. The edge server system 20 may then be made available as a network storage appliance that the access network 14 may provide to allow the clients 16 to access and download content earlier provided by the content provider 18.

Accordingly, the edge server system 20 provides edge storage that achieves a cost effective way for a service provider, whether that is a network service provider, a content delivery network, a web hosting company, an Enterprise IT department, or some other type of service provider, to deploy high capacity storage and delivery devices on the edge of a network. For the purposes of clarity, the edge of a network will be understood herein to encompass network positions where networks touch other networks or end users. However, this description of the term edge network is merely provided for clarifying the illustrated embodiments, and is not to be understood as a definition or a limiting description for the term “edge of a network.” As it will be described in greater detail hereinafter the edge server 20 depicted in FIG. 1 provides a platform that, among other things, makes area networks more intelligent and enables value added service delivery. Thus, the edge server 20 provides for storing and delivering content from the network edge achieving increased profitability and productivity.

Backbone to Edge Server to Access Network

For example, the network 10 depicted in FIG. 1 comprises the backbone network 12 and the access network 14. The backbone network 12 of FIG. 1 is presented to represent the backbone of the Internet. However, it may be representative of a high bandwidth data path of any wide area network. For a content provider 18 to deliver information or content over the backbone network 12, the content provider 18 has to pay for the cost of delivering that content over the backbone network 12. The cost of delivering content over the backbone network 12 can be prohibitive to some types of services. In addition, due to the highly uneven distribution of Internet traffic over time, spare bandwidth to deliver content may not exist at the time the service needs to be offered.

As will be known to those skilled in the art, once the content has traversed the backbone network 12, the content may arrive at an area network such as the access network 14. The access network 14 may be a wide area network that provides network access to customers within the area of that network. For example, the access network 14 may be the network supported by a web hosting company such as, for example, the Exodus web hosting company. In other examples, the access network 14 may be a network owned and operated by a content delivery network, a next generation service provider, a cable service provider, a local carrier, a regional bell operating company or an enterprise. In any case, the access network 14 may exchange information with customers 16, who typically pay a monthly charge for being able to access the access network 14. The costs for delivering content across the access network 14 may be significantly lower than the costs for transferring that same content over the backbone network 12. Accordingly, the access network 14 operator can leverage their reduced delivery costs to provide a service to content providers, such as the content provider 18. In particular, in one practice the area network owner allows the content provider to store content on the edge server 20. The area network operator may then subsequently route requests from a client 16 to receive content from the content provider 18 to the edge server 20. In this way, the clients 16 can access content from the edge server 20 without requiring the content provider 18 to incur the cost of delivering content over the backbone network 12. Thus, the area network operator provides a service to the content provider 18 that reduces the costs of serving content to customers and increases the reliability of delivering content. Moreover, as will be seen from the following description, the edge server 20 provides for delivering content at a pre-established service level, and provides the area network operator with the ability to build redundancy and fault tolerance into the network infrastructure. Additionally, the edge server allows the area network operator to generate additional revenue by providing enhanced network services. Thus, the network operator may employ the systems and methods described herein to provide replication and data storage services, as well as content distribution services, as well as distribution and maintenance of other files and data. Other services may supported or provided, and any such services that employ any of the systems and methods described herein will be understood to fall within the scope of the invention. To this end, in one practice, the network operator may direct requests for data stored at content provider 18 from a client 16 to the edge server 20. For example, the network operation center (NOC) of the access network 14 may redirect client 16 requests from the content provider 18 to the edge server 20. Other techniques may be employed and such techniques include, but are not limited to, the use of proxy caching, transparent caching, DNS redirection, browser proxy settings, NAT servers or other techniques that map a requested IP address to an alternative IP address, the selection of which may turn in part on the application at hand.

Service-level Edge Server

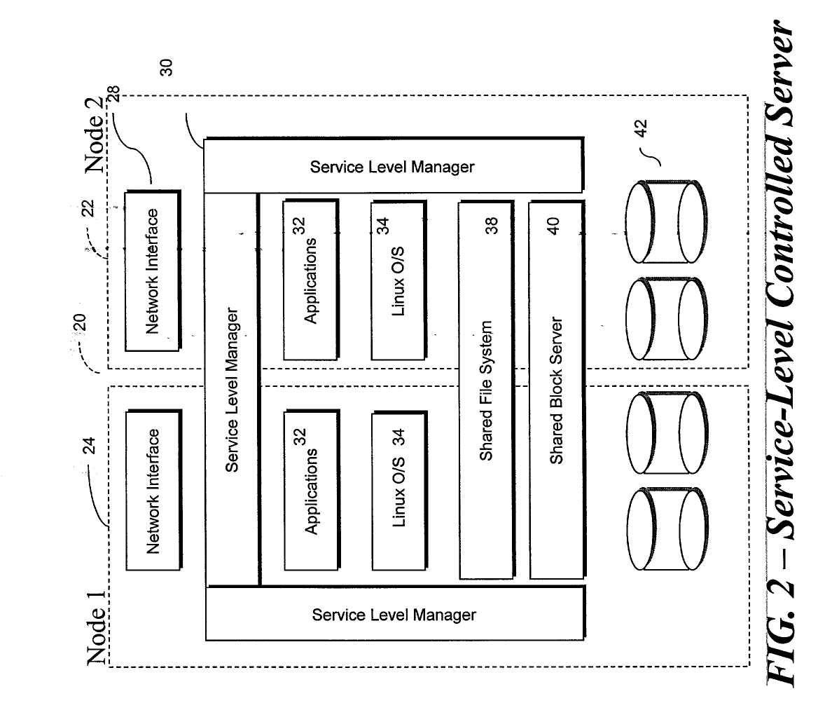

Turning now to FIG. 2, the edge server 20 depicted in FIG. 1 can be seen in more detail. Specifically, FIG. 2 depicts the edge server 20 as comprising first and second nodes 22 and 24 that are joined together to share storage space for storing data and for sharing admission control operations and file system operations. More particularly, FIG. 2 depicts a system 20 that includes a first server 22 and second server 24 that cooperate to act as nodes of a cluster that provide the edge server 20 of FIG. 1. Each node 22 and 24 includes a network interface 28, a shared service level manager 30, application programs 32, an operating system 34, a shared file system 38, a shared block server 40, and data storage devices 42.

The network interface 28 may be a conventional network interface of the type suitable for coupling the server systems 24 and 22 to a data network. One example of a suitable network interface 24 is the PRO1000 Gigabit Ethernet network interface manufactured and sold by the Intel Corporation of Santa Clara, Calif. However, other network interfaces may be employed, and the interface employed may depend, in part, on the network environment and the application.

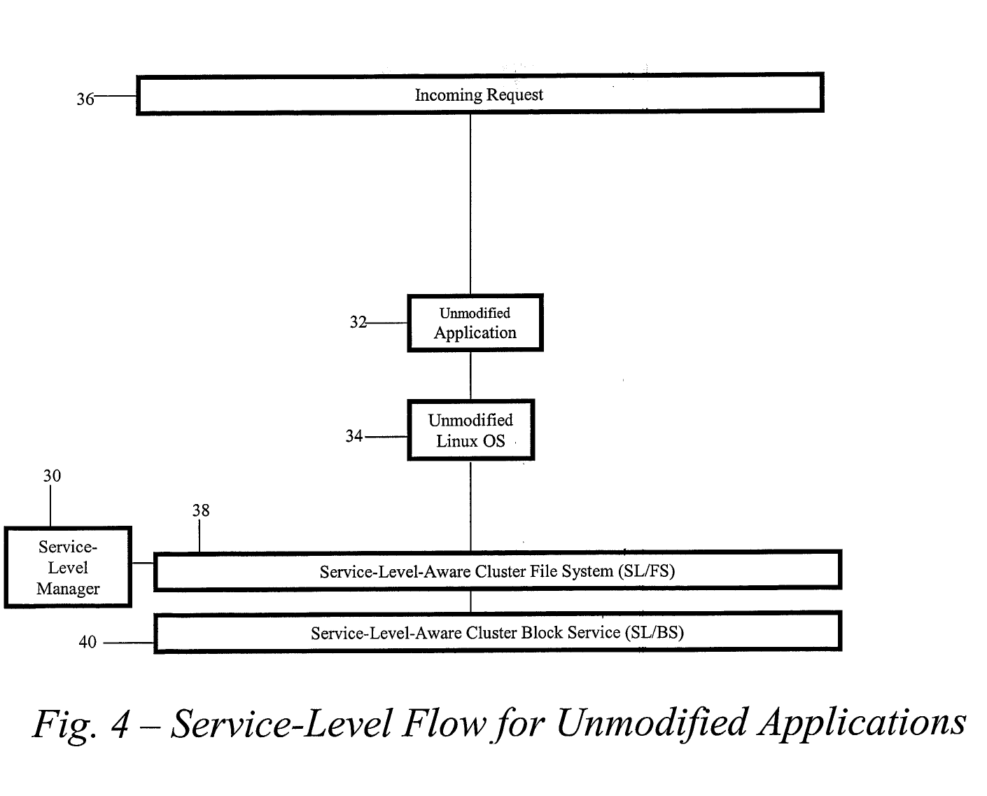

The service level manager 30 depicted in FIG. 2 determines whether the server 20 will respond to a request for content from a client 16. The depicted service level manager 30 is shared across the cluster of node 22 and 24, thereby providing for uniform admission control across the cluster. Additionally, the service level manager 30 is shown as surrounding the components 32, 34, 38 and 40. This illustration shows that the depicted service level manager 30 of this embodiment communicates directly, and optionally, with each of these elements in each of the nodes. As will be described below with reference to FIGS. 4, 5 and 6, different embodiments of the system may have a service level manager 30 that communicates with different components of the system.

In either case, the service level manager 30 may process a request to determine the level of service required by the request and whether the edge server 20 has sufficient capability to provide that required level of service when handling the request. If the service level manager 30 determines that sufficient capability is present, the request will be admitted and serviced. Alternatively, if the service level manager 30 determines that the edge server 20 lacks sufficient capability to service the request at the required level of performance, the service level manager 30 may then reject or redirect the request. In those cases where the server 20 determines that there is insufficient capacity to service the request, an admission control process that may be part of the service level manager 30 may, optionally, redirect the request to another cluster or server. In this optional embodiment, the server 20 can identify other servers capable, or possibly capable, of servicing the request. The server 20 may then redirect the request to the identified alternate server. This process may continue until the request is directed to a server having sufficient capacity to handle the request, or until some other condition arises that results in the termination of the request. In one embodiment, the service level manager 30 may comprise an HTTP server listener process operating across the server nodes 22 and 24 and monitoring a port, typically well-known port 80.

As will be described in greater detail below, the service level manager 30 may, in one embodiment, communicate with the shared file system 38 to determine whether sufficient capacity is available to service the request at a particular level of service. To this end, the shared file system 38 may monitor a system resource to determine whether the resource is sufficiently available to support the request. In alternate embodiments, the server 20 may determine an estimate of the real-time capacity of the server and an estimate of the presently utilized capacity. The service level manager 30 may employ this estimate to determine whether the server 20 can handle the request.

If the request can be supported, the service level manager 30 passes the request to an application 32, that may be for example, a server application 32. For purpose of illustration, the embodiment described herein shall be described as an example where the application 32 is a server process. However, other applications may also be employed, and the application employed will depend upon the particular context and service being addressed, such as video conferencing, content distribution, proxy caching, network storage or any other suitable application. The server process 32 may be executing as an application or a plurality of applications. With multiple server processes 32, in one practice the server processes 32 pass the request round-robin style until a server process 32 is identified that is available to service the client's 16 request. Optionally, the load of each server process may be monitored and the service level manager 30 can deliver the request to the server process 32 best suited to handle the request. Further alternatively and optionally, the server process 32 can cause a server temporal process to be forked. The forked server temporal process receives the client's request and processes it. Other techniques for handling the request may be practiced.

One example of a server application 32, suitable for use with the system 20 is the Apache server, which is commercially available from the Apache software foundation of Forest Hill, Md. As discussed below the server application 32 may also be a modified Apache server, with the modifications that allow for more efficient processing of requests. Other examples include the Real Media server, the Apple QuickTime server and the Windows Media server, all of which are streaming media servers adapted for streaming content over a data network. Servers adapted for storing and caching data or objects may also be used, and the application or server employed will vary according to the services supported by the system 20.

Application programs 32 can include a server program capable of serving content from the data storage devices to a client 16 that has requested the content. In one example, the server program 32 comprises a modified version of the Apache web server program. As those of skill in the art will know, the Apache web server is an open-source web server that is available for commercial use. The Apache web server and methods for modifying or extending the web server are set forth in Laurie et al., Apache, The Definitive Guide (O'Reilly Press 1999), the contents of which are incorporated by reference.

The operating system 34 shown in FIG. 2 may comprise a general-purpose Unix type operating system such as the Linux operating system. Unix type operating systems are described in detail in Maurice Bach, The Design of the Unix Operating System, Prentice-Hall Software Series (1986). However, other types of operating systems, including the various Windows operating systems, embedded operating systems such as VxWorks from WindRiver and proprietary operating systems such as OpenVMS from Compaq Computer Corporation may be employed without departing from the scope of the invention.

As further shown in FIG. 2 the edge server 20 includes a shared file system 38 that spans nodes 22 and 24 within the cluster. The shared file system 38 may be, in one embodiment, a kernel service that links to the Linux kernel and supports file access. For example, in one practice, the shared file system 38 is capable of handling file structures that include within their meta-data information regarding the level of service that is to be provided when delivering the content associated with that file over a data network.

Specifically, Table 1 below presents one example of a data file of the type that may be manipulated and processed by the shared file system 38. Table 1 depicts pictorially the data fields of a file structure that includes meta-data representative of service level information, file name information, and an Inode table that points to the data blocks on the disks 42 that contain the data associated with the file represented by Table 1.

TABLE 1

File Name
CGID
Inode1
data block 1
Inode2
data block 2
. . .
. . .
Inoden
data block n

In one embodiment there are two types of meta-data:

File System Meta-data: this includes the standard meta-data that is typically associated with a data file, and a group id such as the depicted content group id (CGID) that may be employed by the system 20 to index into a content-based service-level table; and

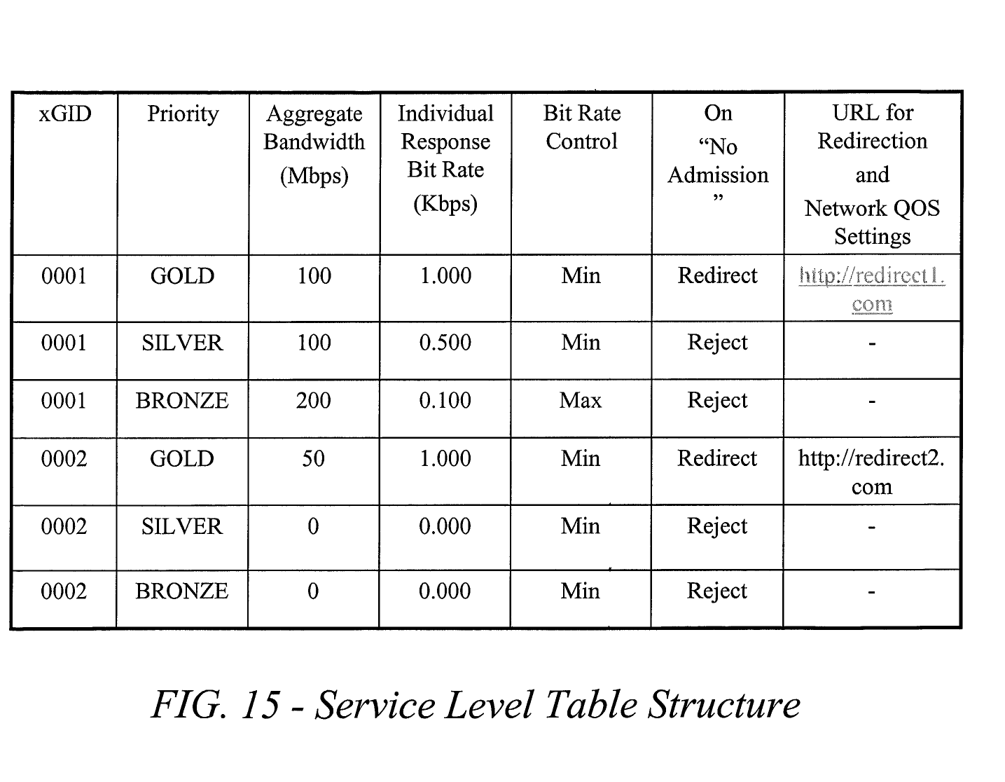

Service-Level Meta-data: information used to define the service level for a request. In one practice there are three defined tables. A content-based table indexed by the CGID, an Application-based table indexed by the Application group ID (AGID), and a Requestor-based table indexed by the requester group id (RGID). An example of such a table is set forth in FIG. 15, with examples of different levels of service presented therein.

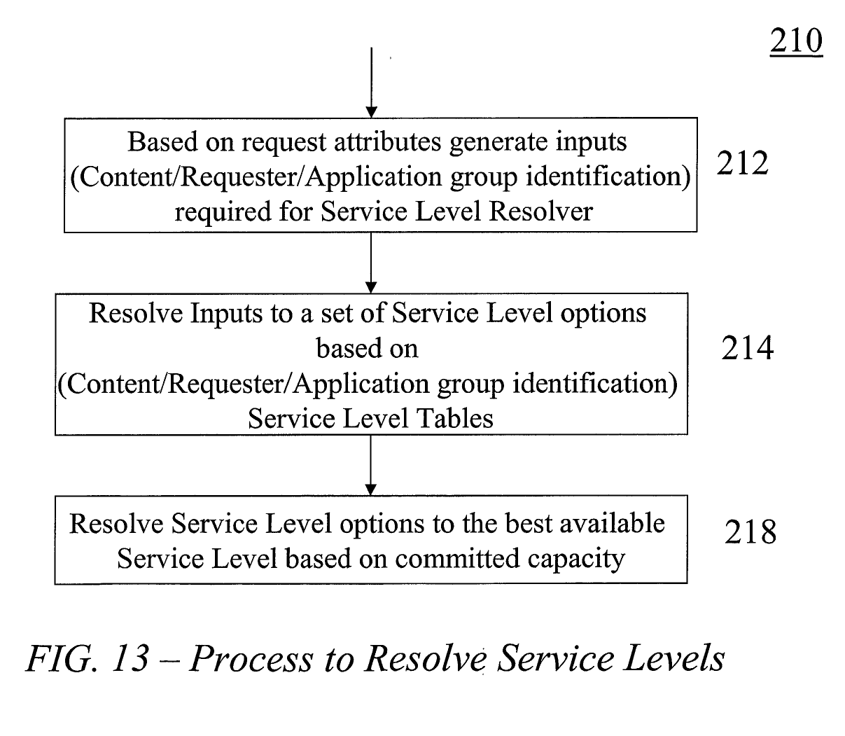

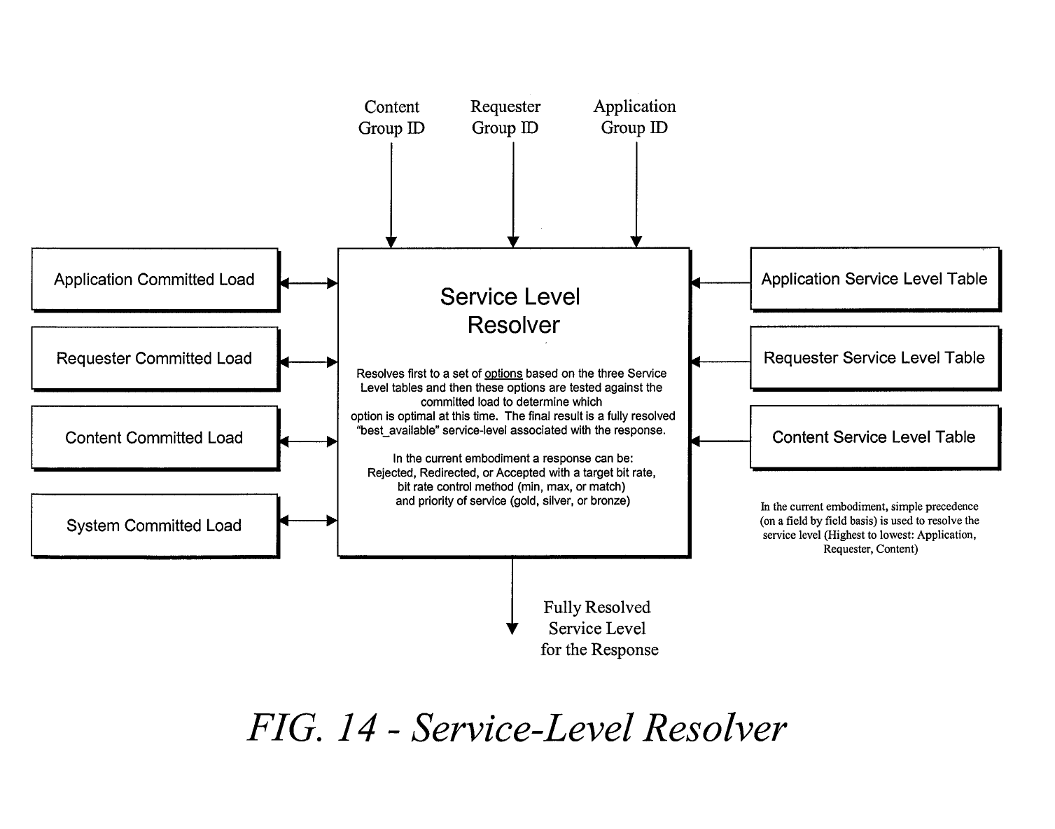

In the embodiment depicted by Table 1, the meta-data for a file includes a content group id number (CGID) which is used to associate this file with a set of content-based service level fields contained in a Content Service Level Table (CSLT). The use of the CSLT and the CGID to determine the proper level of service to provide the requested content is discussed below, among other places, with reference to FIGS. 13 and 14.

In other embodiments, the file meta-data may include multiple service level fields provided for storing information representative of the service level. In still other embodiments, the meta-data may include one field of service level data for each attribute considered by the system (i.e., content, requester, application). In such an embodiment, the separate fields of service level information may be associated with different aspects of service or different participants within the data transfer application. For example, the meta-data may store service level information representative of a level of service to provide to the content, typically the file, selected by the client 16 and a different class of service to provide if the user is from a certain group. The shared filed system 38 may differentiate between the plural levels of service.

In this application, each class of service may be representative of a different level of attention that the system 20 will provide to a request, or a different level of priority the system 20 will provide to a request when scheduling services for delivering the requested content to a client 16. Optionally, as described above the level of service provided maybe associated with the content requested, the application 32 employed, and the different participants within the data transfer process. For example, in certain embodiments, the data file may have a service level class field that is associated with the client 16 requesting the content. In these embodiments, the system 20 may be cognizant of network side information, such as the client 16 making the request, or the network over which the request was made. In any case, the data file may include meta-data representative of the level of service to provide to a request coming from a particular client 16, a particular network 14, or based on other network side information. In other optional embodiments, the data file may include a field representative of a level of service to provide content being delivered by a certain application 32.

In other applications the level of service may be a function of other features or attributes, and particular features involved will turn in part on the application at hand. For example, in other applications the systems and methods described herein may provide for mixed class of service for the same content. Thus, the meta-data may include information that associates the data with more than one level of service. The level of service selected for a particular user can vary on a number of factors including, but not limited to, user choice, the level of service available, or some other factor representative of the operating state of the server 20. Additionally, the meta-data may support different levels of service based on whether data is being transmitted from the server 20 or received by the server 20. For example, in some applications the systems described herein may be employed for storing data. In these applications, the meta-data may include information representative of the rate at which data is to be received and, optionally, stored. The rate at which data will be received may vary according to the level of service applied by the server 20. The level of service applied may vary according to the meta-data, which may include service level parameters that vary according to the entity sending the information to be stored, the type of data being stored, and other such factors.

Thus, in one embodiment, the file structure employed by the shared file system 38 may include meta-data that indicates a required service level parameter, such as a required bit rate for delivering the content, wherein the required bit rate may have a minimum and a maximum value. Other meta-data can include pricing information, licensing information, the number of streams that may be generated simultaneously from the data file, the application being employed, the type of the data or content and other such information.

Service-level Flow Options

FIGS. 4, 5 and 6 show functional block diagrams for different embodiments of the invention where the meta-data stored with the file can vary. For clarity the different embodiments are shown as separate embodiments running on the edge server 20. However, it will be understood that the edge server 20 provides a platform that can execute the three separate embodiments simultaneously on the same platform. Moreover, the systems and methods described herein contemplate embodiments, wherein the different embodiments of FIGS. 4-6 execute simultaneously on the same computer or server, while communicating among each other. This allows the system 20 to broker a request among the different embodiments, and to identify the embodiment best suited to handle an incoming request. For example, the system 20 can determine what type of service level information (i.e. service level information based on the content selected, or service level information based on, or including, network-side information) is to be processed when scheduling an incoming request. The system 20 may then identify the embodiment most suited for processing a request having that type of service level information.

For example, turning to FIG. 4, the system 20 is depicted as a functional block diagram that includes an application 32, an operating system 34, a service level manager 30 that communicates with the shared file system 38 and the shared block server 40. In this first embodiment the system 20 is adapted to support managed responses controlled by application and/or content based service level agreements. In this embodiment, the application 32 may be a commercially available unmodified application, such as the Apache server program. An incoming request that is admitted by the admission control of the service level manager 30 may be passed, as shown, to the unmodified application 32. The unmodified application 32 can make a file open request that directs the operating system 34 to open the file associated with the client request. In response to the file open request, the unmodified operating system 34 can request the shared file system 38 to retrieve the data on the disk 42 that is associated with the file request of the application 32.

The shared file system 38 may employ a distributed meta-data table that includes the meta-data associated with the respective file. The shared file system 38 may collect the meta-data information and pass that information to the service level manager 30. The service level manager 30 processes the meta-data to determine whether the request can be serviced according to the contracted service level. It will be noted that in FIG. 4, the service level manager 30 is shown as a separate element in the system 20, but it will be understood by those of ordinary skill in the art that optionally the service level manager 30 may be integrated into the shared file system 38, or other processes within the system 20.

The service level manager 30 takes the class of service information and determines whether system resources are available on system 20 to implement the request in compliance with the contracted service level. The system resource monitored by the service level manager 30 may vary according to the application and can include system resources such as disk access, processor availability, network bandwidth, memory availability, and other resources and combinations of resources. In the depicted embodiment, the service level manager 30 monitors disk access availability to determine whether the request may be serviced in compliance with the contracted service level. Accordingly, the service level manager 30 is capable of looking at the service level data associated with a file, and determining whether a new request for service, at that level of service, may be handled by the system 20.

In one practice the block server 40 determines whether a request may be serviced by the system by estimating the available real time capacity of the system. In one embodiment, the real-time capacity of the server 20 is determined by estimating the capacity based on the expected performance of the server 20. In those embodiments where the server 20 is well behaved an estimate of this real-time capacity may be made, either off-line or dynamically. In either case, the predictable behavior of the server 20 allows for making an estimate of the server's real-time capacity. For example, the system may estimate that the server 20 has a capacity of about 800 Mbit/sec. This estimate may be determined by modeling or testing the behavior of the server 20, including the rate at which the application program 32 and file system 38 can respond to a request for data. Additionally, the above described server 20 has well behaved disk devices that allow for modeling the disk access time for reading and writing data to/from the disk. Other parameters and characteristics of operation may also be taken into account when modeling the system operation.

Further, the real-time capacity that is required to service a request may be determined, at least in part, by modeling or empirical testing. For example, in one practice the server 20 identifies requests being processed by the system. The requests may be sorted into different categories, such as into categories of size, where there are for example ten ranges for the size of the data files being requested. By collecting data on real operations, for example the last 250 operations, the server 20 can determine the actual rate at which requests have been serviced. Once this model is complete, the server 20 may use this model the next time a subsequent request is received. This allows the server 20 to determine the capacity that is to be employed when servicing this request. By comparing the capacity to be used against the modeled real-time capacity, the server 20 may determine whether the request may be serviced. Additionally, each time a request is accepted to be serviced, the server 20 may decrement the available real-time capacity for handling future requests.

In a multi-class system, the server 20 may optionally make determinations on whether a request may be serviced based, in part, on the level or class of service to provide the incoming request, or to leave available for other classes of services. For example, in a system with 800 Mbit/sec of capacity, the server could allocate all the available capacity to requests at the highest level of service. The determination of the level of service to provide a request may be based on the requester, the content requested, the application servicing the request or other factors. Only requests at the highest level of service would be supported even if capacity was available when a request of lower priority came in.

In other examples, the system could allocate 400 Mbit/sec of capacity to the highest class of service and the remaining 400 Mbit/sec of capacity to two lower classes of service. In this example, the server 20 could refuse any request at the lower classes of service that would commit the server 20 to a capacity greater than 400 Mbit/sec, as this would interfere with the ability of the system to service requests at the highest level of service. Optionally, if a request at the highest level of service can not be accepted, the service level manager 30 could check if service would be available at another level of service. In this manner, the system can broker requests, if appropriate, between different levels of service.

In optional practices the server 20 may be over subscribed. For example, in the system with 800 Mbit/sec of capacity, the server 20 could allocate the full system capacity to be jointly employed by all classes of service. Thus, in this example if there are three classes of service GOLD, SILVER and BRONZE, the system can allocate 800 Mbit/sec for GOLD service, 800 Mbit/sec of capacity for the SILVER level of service and 800 Mbit/sec for the BRONZE level of service. However, in this practice the over subscribed machine may use precedence to ensure that requests for service at the GOLD level of service are always handled, even if that requires refusing or ending tasks currently executing at a lower level of service. Thus a machine that has 800 Mbit/sec of capacity and which is operating at 800 Mbit/sec of capacity with 500 Mbit/sec of capacity employed for supporting a GOLD request and 300 Mbit/sec of capacity employed supporting the SILVER and BRONZE levels of requests, may be fully committed. However, an incoming GOLD level request may still be serviced by the system 20 when, in this practice, the system will terminate a sufficient number of tasks at lower levels of services, the SILVER and BRONZE level of services, to free up sufficient capacity to handle the GOLD request. In this way, the machine may be oversubscribed in that the total capacity available to the system may be sold and resold at different levels of service. However, this may be acceptable to those purchasing lower levels of service wherein the understanding is that tasks being supported at lower levels of service may be less costly but may also be terminated or deferred to provide capacity for requests at a higher level of service.

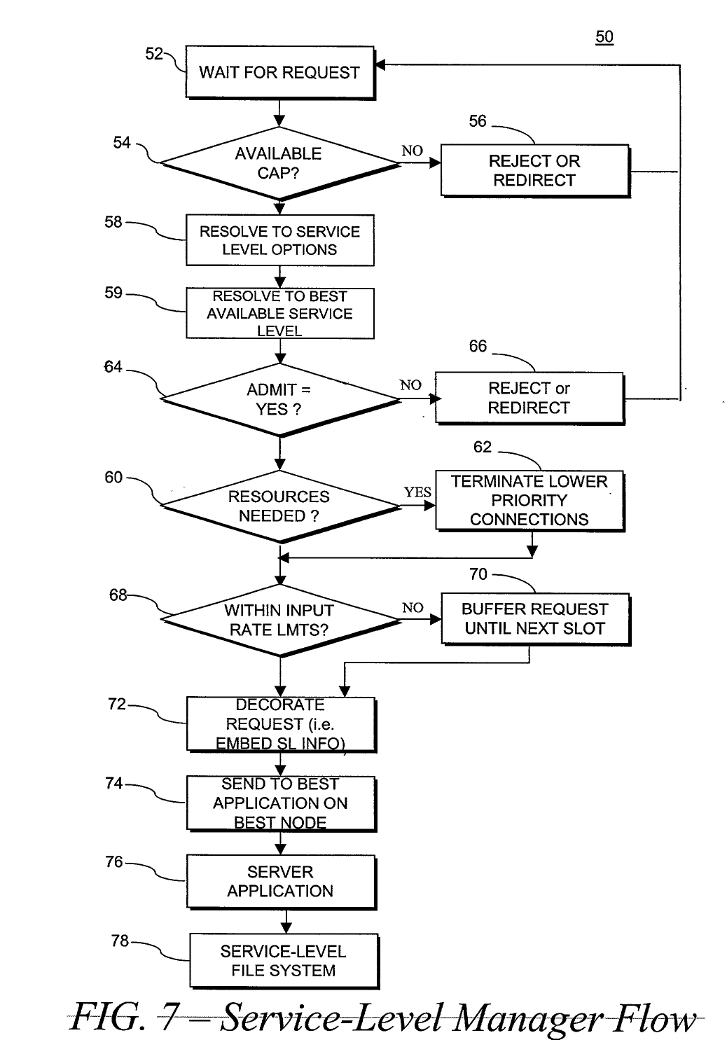

In one practice, once the service level manager 30 determines a request may be serviced, the block server 40 may optionally verify whether the request may be serviced and may determine a schedule for handling the request by determining a deadline for the data blocks that need to be read to service the request. In particular, given the bit access rate for the drive 42, and the size of the data blocks to be read for servicing the request, the block server 40 may determine the amount of time it will take to read the blocks for servicing the request. Thus, the block server 40 can translate a request into a time period representative of the amount of required disk time for servicing the request. This information may be employed to determine a schedule among pending requests that the system has already accepted. For the embodiment of FIG. 4, once the request is admitted, the system 20 is certain that it can request data blocks from the disks 42 at a rate sufficient to deliver the associated class of service. In contrast, if the request cannot be scheduled to service the request at its contracted level of service, the service level manager 30 may refuse the request. In one embodiment, this is achieved by delivering to the operating system 34 an HTTP 403 error permission denied response that is handed back to the application 32, resulting in the request being refused. Optionally, the service level manager 30 may include an admission control process that may act as a process for informing the client 16 that its request has been refused. In the cluster based system, the service level manager 36 may also redirect the request to another node that may have capacity to handle a request at the identified class of service. One particular process for handling an incoming request for service is depicted in FIG. 7.

Request to Service-level Controlled Response Flow

Specifically FIG. 7 depicts a process 50 for reliably providing end to end service level performance. The process 50 commences in operation 52 wherein the edge server 20 is waiting for a request. The request can be a typical HTTP request, such as a Get request. However, any suitable type of request may be employed herein and the system is not tied to any particular protocol. Once the request is detected the process 50 proceeds to block 54 wherein the process 50 determines whether capacity is available at the highest level of service. If the capacity is not available, the process 50 proceeds to block 56 wherein the request is rejected or is redirected to a different IP address. If however, the capacity is available the process 50 proceeds to block 58.

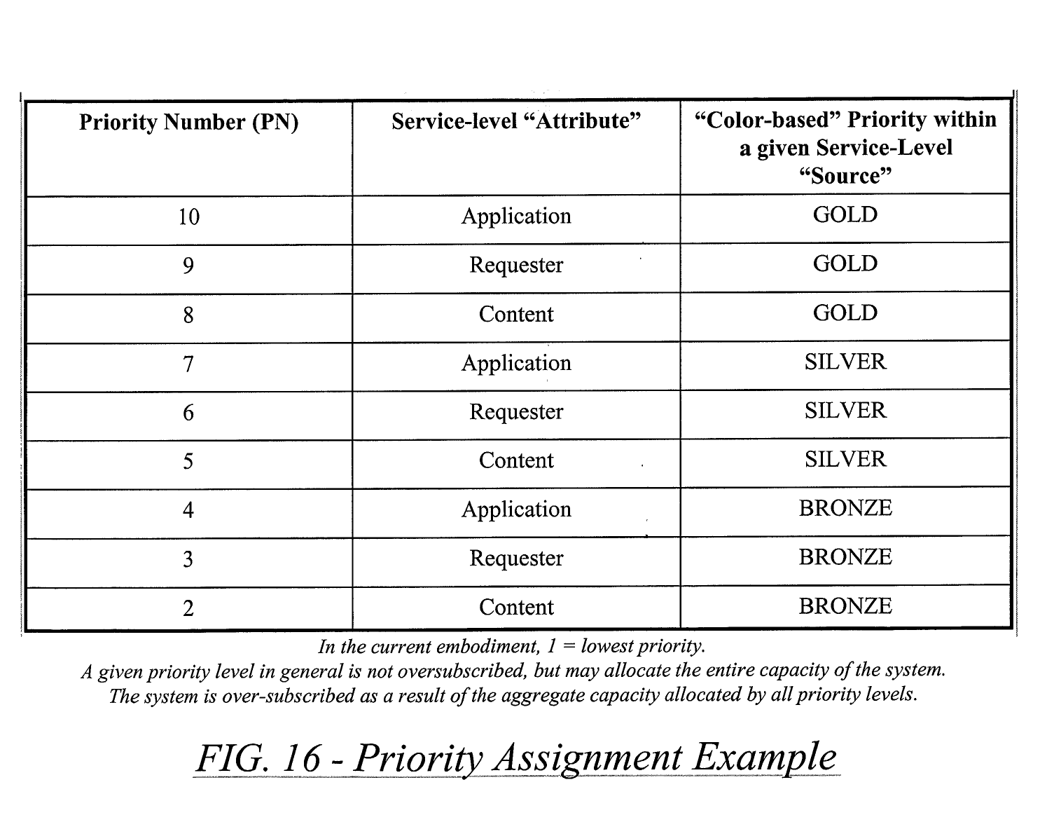

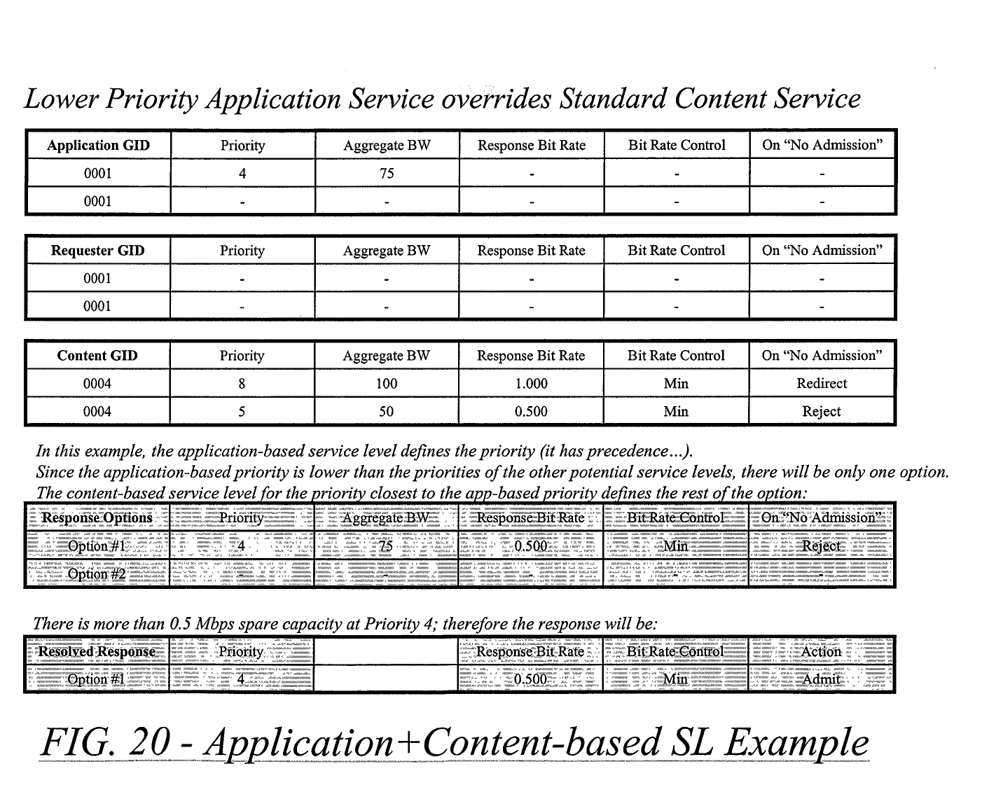

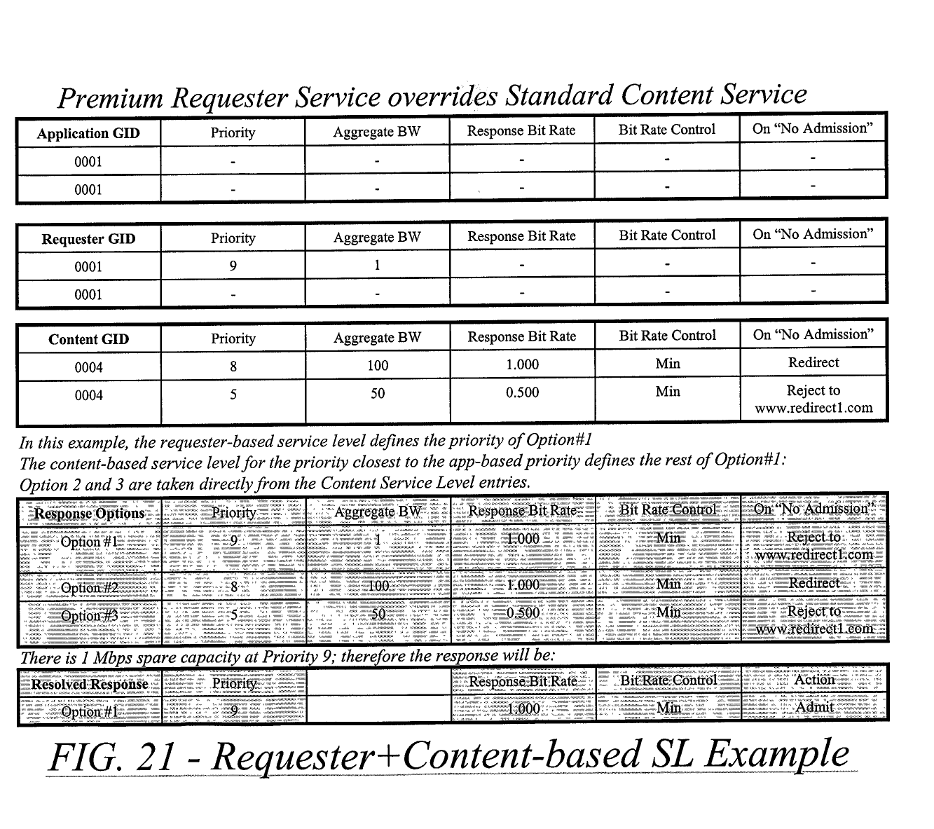

In blocks 58 and 59 the process 50 classifies the request. In these operations the process 50 derives the service level information for a given request based upon the content requested, the identification of the requester, the type application which will provide the response and a set of rules which describe how to mediate conflicts between these three sources. In the embodiment of process 50, there is a step 58 determines the service level options for the request. Examples of the service level options are presented in FIGS. 20 and 21. The different options associated with a request may represent the different levels of service a user or content provider has contracted for. Thus, for a single data file, a content owner may have agreed to have the file distributed at either of the two highest levels of service. Thus, the process 50 may find two options for the service level to associate with the requested content. Once the options are identified the process 50 moves to operation 59 to resolve, for the given options, the level of service to provide. To select among the different options, the process 50 may use any suitable technique including the rules of precedence set out in FIG. 16 and rules that consider the committed loads of the system, as set out in FIG. 14.

After the request is classified the process 50 proceeds to 59. At 59 the process 50 determines the best available service level from the resolved options and the committed capacity of the system at this time. The available service options may include: reject, redirect, or admit. If admitted, the service level may include priority, bit rate, and the method of managing the bit rate (minimum, match, or maximum). At decision block 64 the process 50 checks if the resolved service level is Admit. If not, the resolved service level was either Reject or Redirect and the proper operation will be performed in block 66. At decision block 60, the process checks for sufficient resources to handle the new response. If sufficient sources do not exist, than lower priority connections are terminated in block 62 to free up sufficient resources. At decision block 68 the process tests whether accepting the request at this time would exceed input rate limits. Aggregate input rate limiting prevents bursty request traffic from temporarily overtaxing the resources of the system. Requests which meet the admission criteria but exceed the input rate limit may be temporarily stored and processed as fast as the input rate permits. To this end the process can proceed to block 70 wherein the request can be buffered until the next slot is available. In either case the process will proceed to 72 wherein the process 50 decorates the request with the service level information. To this end the process in block 72 may embed the service level information into the request. After this step the process 50 may proceed to block 74 wherein the process determines the best application on the best node for handling the present request. Once this node is determined the server application, in block 76, takes over and serves the content to the user. As previously shown in FIGS. 4-6, a server application typically interacts with a service-level file system. This file system may parse and act on service-level information embedded in the file system request without any support on the part of the application. A service-level file system is contained in block 78.

Other practices for allowing the system 20 to refuse a request may be practiced with the systems and methods described herein and the particular technique for refusing a request can vary according to the application.

Disk Scheduling in a Service-Level Block Service

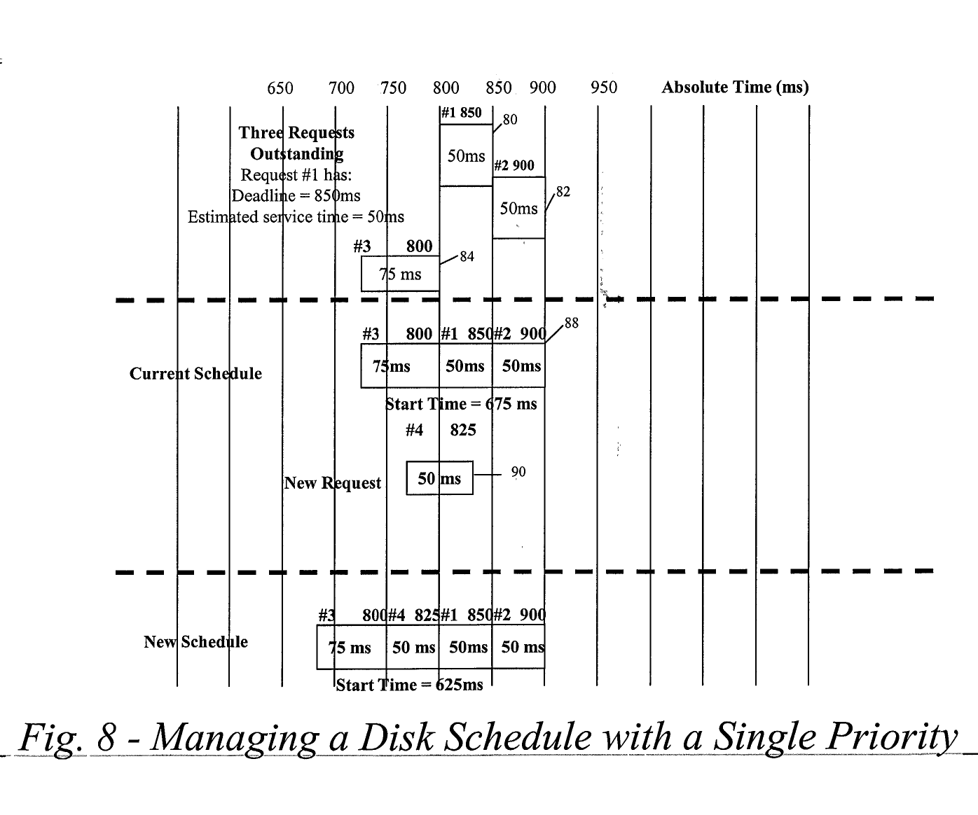

One scheduling process suitable for use with the systems herein is depicted in FIG. 8. Specifically, FIG. 8 depicts a block service scheduling example for an embodiment wherein a single disk 42 stores the content files that will be requested by clients 16, and wherein the service-level for each content file has the same priority

To this end, FIG. 8 shows a schedule prepared by the block server 40 and presented in FIG. 8 as a timeline, in milliseconds, that progresses with increasing time from left to right. FIG. 8 further shows that the system 20 has received three outstanding requests, requests 80, 82 and 84 respectively. Request 80 has a computed deadline of 850 milliseconds and estimated service time of 50 milliseconds. The estimated service time of 50 milliseconds may be determined by the service block server 40 by multiplying the bit access rate for the disk 42 by the expected number of bits to be read to service the request. Requests 82 and 84 are similar in that they have scheduled deadlines, in this case a deadline of 900 milliseconds and 800 milliseconds respectively and each have estimated service times of 50 milliseconds and 75 milliseconds respectively. FIG. 8 further shows that the three requests 80, 82 and 84 may be aligned and scheduled by the block server 40 into a schedule, depicted as schedule 88. As can be seen from FIG. 8 schedule 88 represents a composite of disk accesses that begin with an access to service request 84 which begins at 725 milliseconds so that it may be completed, after its 75 millisecond estimated service time at its deadline of 800 milliseconds. Similarly request 80 may then be serviced commencing at 800 milliseconds, continuing for 50 milliseconds, and completing at its scheduled deadline time of 850 milliseconds. Similarly, request 82 may begin at 850 milliseconds, continue for 50 milliseconds, and complete at 900 milliseconds its scheduled deadline. Thus the current schedule provides for all three requests 80, 82 and 84 to be serviced on time.

However, FIG. 8 further shows that a new request 90 may arrive before the system 20 has begun servicing the current schedule of requests 88. Specifically, FIG. 8 shows a new request 90 arises that has a scheduled deadline of 825 milliseconds and an estimated service time of 50 milliseconds. Upon receipt of this new request 90, the service level manager 30 can determine whether there is sufficient capacity in the system 20 to handle the request while still meeting the scheduled demands of earlier accepted requests 80, 82 and 84. As can be seen from FIG. 8, the block server 40 is capable of generating a new schedule, 92 that accommodates this new request 90. Specifically, the new schedule 92 shifts forward the beginning of the current schedule 88 by moving request 84 forward in time by 50 milliseconds. In this way, the start time for the new schedule is moved to 675 milliseconds. This allows the request 84 to commence at 675 milliseconds and complete 75 milliseconds later at 750 milliseconds. This 750 millisecond completion time for request 84 is 50 ms ahead of its earlier scheduled deadline of 800 milliseconds. During the intervening 50 ms period between the ending of request 84 and the beginning of servicing request 80, the block server 40 has sandwiched the 50 ms estimated service time for request 90 into the new schedule 92. This allows the request 90 to commence at time 750 milliseconds and complete by time 800 milliseconds, which would be 25 milliseconds ahead of its scheduled deadline. As can be further seen, the earlier scheduled requests 80 and 82 may begin during the same scheduled periods as were set up in schedule 88.

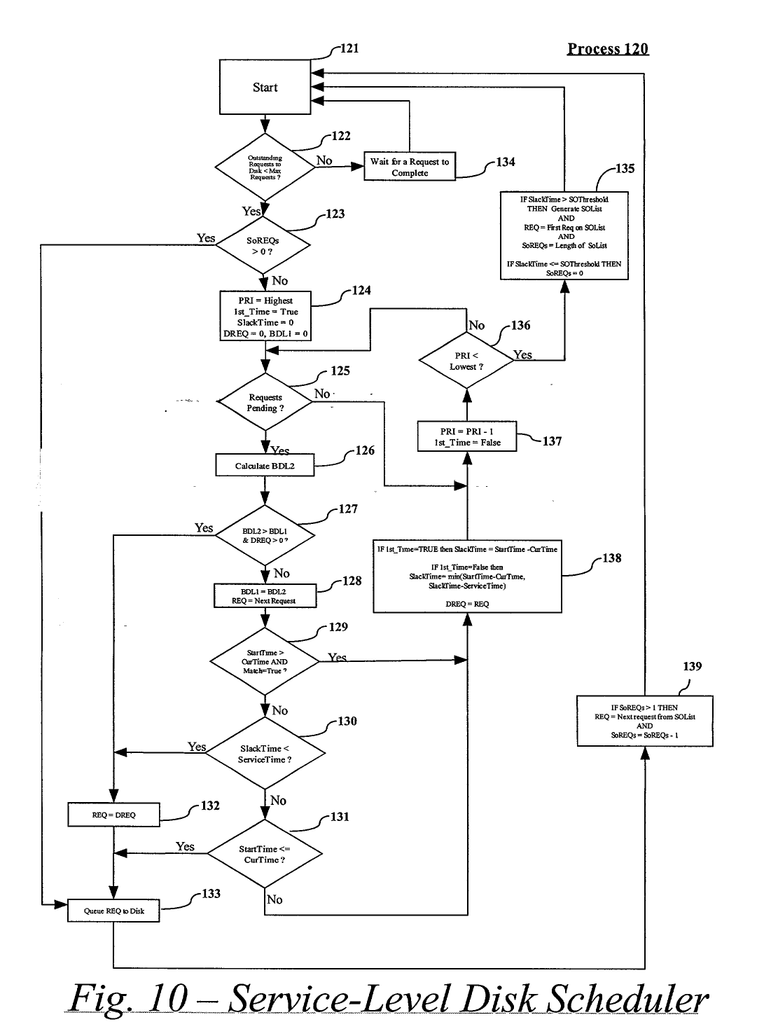

As also can be seen from the above description, the service level manager 30 attends to the requests at the highest level of service first. For some applications, such as streaming media applications, this may result in the service level manager 30 continuously scheduling the highest requested level, without supporting the lower service levels even though the system 20 has capacity to service the other requests as well. For example, in streaming media applications the client 16 may be a media player, such as the real media player. These clients have a tendency to aggressively “prefetch” data from the server application 32 far ahead of the need by client 16. To address this issue, as well as other issues that may arise, the system 20 may perform a slack-time scheduling operation that takes advantage of the system's knowledge of the rate at which a client 16 needs to receive data and still be in compliance with the agreed to service level. For example, the system 20 can determine, based on the computed deadlines, when there is open time within the schedule plan to accommodate a request for service at a lower level. It may further use knowledge of disk drive behavior to maximize disk performance (for instance by re-ordering disk requests) while still meeting required deadlines. One such process for performing this slack time scheduling is depicted in FIG. 10, explained in more detail below.

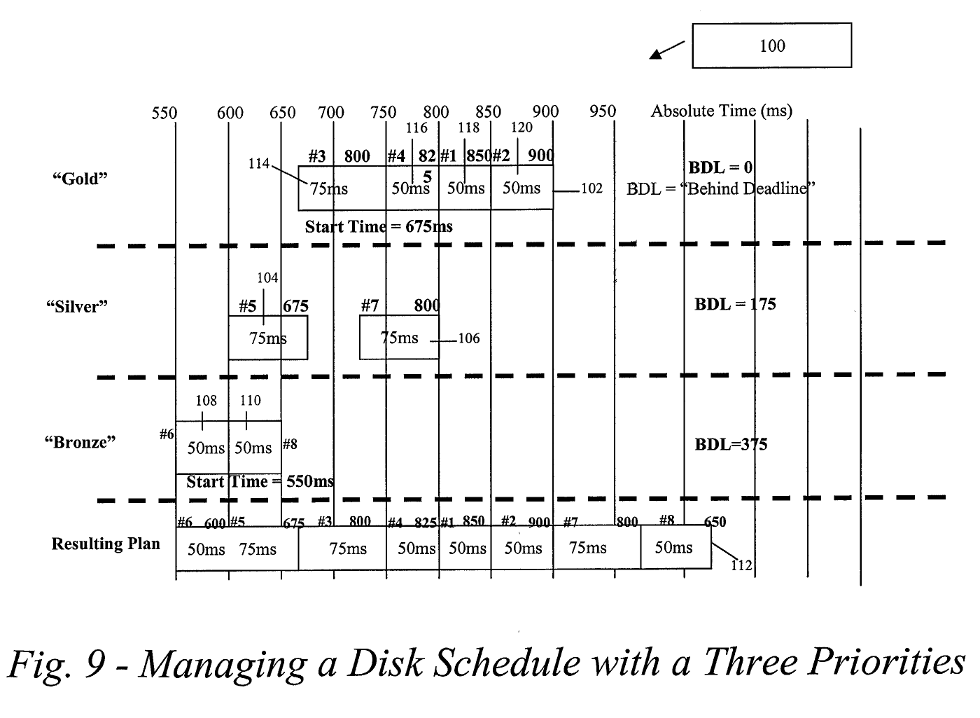

FIG. 9 depicts another example of a block service schedule, wherein multiple requests with different levels of priority are scheduled. It will be understood that in this embodiment the block server 40 schedules requests to serviced at some future time, and accordingly in this example the current time may be 500 ms and the response to the request is being scheduled to take place some time after 500 ms. FIG. 9 depicts the schedule prepared by the block server 40 and presented in FIG. 9 as a timeline, in milliseconds, that progresses with increasing time from left to right. FIG. 9 further shows that the system 20 services requests having different priorities. For the depicted embodiment, these levels include three different priorities, such as a gold, silver and bronze level. A priority may represent the level of attention that the system 20 will provide to a request. This level of attention may include that a guarantee that requests at one level will only be handled if they can be serviced at a agreed to rate of delivery, or that requests at one level will be serviced ahead of requests at other levels.

FIG. 9 depicts that the plan 100 has received four requests at the highest level of service, the gold level. The four requests, 114 through 120, are successive and begin at 675 ms and end at 900 ms. At the next lower class of service, silver, the system 20 has received two requests 104 and 106, and at the lowest class of service, the system 20 has received two request 108 and 106. To schedule these requests, the block server 40 generates the resulting plan 112 that schedules the system 20 to begin servicing requests at 550 ms. The first request scheduled to be serviced is the bronze level request 108. After 108 is scheduled, the system 20 will handle silver level request 104. The system 20 then handles the gold level requests 114, 116, 118 and 120. Each of these gold level requests is scheduled to be completed by the computed deadline, and is scheduled to be serviced because the system 20 has sufficient system resource capacity, in this case disk access, although other capacity such as network bandwidth or some other resource or combination of resources, could be monitored. After the gold level requests are serviced, the block server 40 schedules the silver level request 106 to proceed. This request is serviced after its computed deadline of 800 ms. As can be seen this request is scheduled to complete at 975 ms, when its computed deadline was 800 ms. Thus, this request 106 is serviced 175 ms behind deadline. In this case, the behind deadline servicing is allowed because the silver class of service lacks a warranty that a request at this level will get serviced at deadline if a higher priority request exists. After the request 106, the block server 40 schedules the remaining bronze level request 110. As can be seen this request 110 is serviced 375 ms behind schedule, and is attended to after the silver level class request 106 is serviced.

As can be seen from FIGS. 8 and 9, the system 20 may employ system resources to determine whether a request at a given level of service may be performed. As described above, this may be done by tracking the committed capacity of the system. In other practices this may be done by trying to schedule access to the resource. For example, if an incoming gold level request was received by system 20, with a completion time of 825 ms and an estimated service time of 75 ms, the service level manager 30 may determine, based on the schedule 112, that the system 20 lacks the resources to handle that new request, and the request may be handled as set out in the process 50 of FIG. 7, or by some other suitable process. In other embodiments, different techniques may be employed to determine whether a request may be serviced and the technique employed can vary depending upon the application at hand.

Disk Scheduler Process for a Service-Level Block Service

FIG. 10 depicts a process 120 suitable for use by a system to schedule disk requests to a single disk drive based on a service-level driven schedule plan which uses the previously introduced concept of slack time. This process supports:

1. An arbitrary number of priorities.

2. A target bit rate based service level model which translates target bit rate into a deadline, estimated service time for a given request, and finally a required start time.

3. Two types of bit rate control (MIN which is the default and MATCH)

4. Request reordering to maximize disk performance as long as it complies with service level requirements

The bit rate control options provide the ability to more precisely define the way a target bit rate will be supplied for a given request. For example, a streaming media response would typically require a guaranteed minimum bandwidth with a desire for more if available. A file download over a network with limited bandwidth may want to be delivered with a constant bandwidth which is a portion of the total network bandwidth. The MIN (default) bit rate control option attempts to provide no less than the specified bit rate but is free to exceed this bit rate if resources are available and while MATCH attempts to maintain a constant bit rate under all conditions. Process 120 can be extended to support MAX bit rate control which would attempt to never exceed the specified bit rate and would have more freedom to provide less bandwidth under resource contention.

The throughput of a disk drive is greatly affected by its access pattern. Process 120 uses its knowledge of service level requirements to re-order disk requests in a way which maximizes disk throughput as long as the service-level requirements can be met. Experiments have shown performance gains of 15-50% by using this technique and it has the added advantage of lowering power consumption. Controller-based seek optimizations are in use today but none to our knowledge have service level requirement understanding which prevents request re-ordering when it would result in a failure to meet a service level. In making scheduling decisions, process 120 resolves conflicts by applying the following rules in priority order:

1. Make deadline on the highest priority request

2. Deliver a near constant bit rate on requests with the Match option

3. Maximize disk throughput by re-ordering requests

Process 120 starts at block 121 and proceeds to block 122. At block 122, the number of outstanding requests currently queued to the disk is checked against a specified maximum. This maximum may be a static value or may be dynamically derived based on current and historical information. This check permits process 120 to flexibly control the amount of work queued to the disk drive at any given time. The tradeoff is that more work queued to the disk drive can improve disk drive throughput by allowing more overlap in command and data processing, as well as, controller-based seek optimizations. On the downside, the work queued to the disk drive cannot easily be bypassed should the service level requirements change. Further, since the algorithm used for controller seek reordering typically is implemented in microcode and is not formally specified, there is always the risk of unexpected behavior. As a result process 120 attempts to maintain a minimum number of requests outstanding at the drive and as previously discussed performs its own request reordering in compliance with service level rules.

If the number of requests outstanding is already at the maximum, then process 120 waits at block 137 for a request to complete. Control moves to block 121 when a request has completed.

If the check at block 122 succeeds then process 120 proceeds to block 123 where a check is made for the existence of a seek-optimized request. A seek-optimized request is a request which can be efficiently performed based on the last known position of the disk heads. In process 120, a seek-optimized request exists only when the system has slack time greater than a defined threshold (SOThreshold). In this way, process 120 can trade off latency for some individual requests in order to increase the overall through-put of the system by re-ordering some requests. In all cases, process 120 can make the decision about whether to seek optimize with knowledge of the impact to service-levels for each on-going response. In the current embodiment, process 120 is very conservative and will only re-order if it has slack time at all priorities. A variation of process 120 designed to optimize high priority responses could seek optimize the highest priority requests even if there is insufficient slack time for the lower priority responses.

Process 120 checks for the existence of a seek optimized request by testing the value of SoREQs. If SoREQs is greater than zero then at least one seek optimized request exists and, process 120 proceeds to block 133, where the request is queued to the disk. Control then passes to block 139 where the seek optimized request state is updated if more seek optimized requests exist. After block 139 process 120 proceeds to start block 121.

If the test in block 123 fails, then process 120 proceeds to Block 124. block 124 performs initialization for the main request processing loop of process 120. These initialized variables include:

PRI—The number representing the priority level of the request (10 to 0 in this example). 10=Highest Priority; 0=Lowest Priority.

1^{st}_time—A flag which indicates whether this is the first pass through the loop.

SlackTime—The amount of spare time at higher priorities available to schedule a request at a lower priority.

DREQ—Deferred Request variable which holds a pointer to the first request to be performed at a higher priority level should process 120 be unable to schedule any request at a lower priority level. A value of zero indicates that there is no higher priority request.

BDL1—Behind Deadline 1 variable which stores accumulated time behind deadline information for a single request queue.

Control proceeds to block 125, where process 120 determines if any requests are pending at the current value of PRI. If no Requests are pending, control moves to block 137 where PRI is decremented and then in block 136 a check is performed to see if PRI is set below the lowest priority. If so, control moves to block 135 to generate a seek optimized list of requests if there is sufficient slack time in the schedule and then process 120 proceeds to the start block 121. If PRI is a valid priority level, control moves to block 125 to check for requests at the new value of PRI.

At block 126 process 120 uses historical request completion information to calculate a behind deadline value for the current queue. At block 127 a behind deadline check is made which determines if a higher priority queue has historically been farther behind than the current priority. If so and a request is pending at the higher priority (indicated by DREQ>0) then control moves to block 132. REQ is loaded with the value of DREQ at block 132. At block 133 this request is queued to the disk. Control then moves back to the start block 121 through block 139. Since the request which was just queued to disk was not seek optimized, block 139 will not update any state.

If the test performed at block 127 is not true then in block 128 the value is BDL2 is saved in BDL1 and REQ is loaded with the next request at this priority. Control moves to block 129 where Process 120 determines if is not yet time to schedule a request which has selected Match control. If yes then control moves back to the request loop (block 124) through blocks 138, 137, and 136.

If the test at block 129 fails, control passes to block 130 where Process 120 determines whether the slack time is smaller than the estimated service time for REQ. If there is not enough slack time, then the deferred request (DREQ) will be queued to disk through blocks 132 and 133.

If there is sufficient slack time then control moves to block 131 which makes a final determination if REQ will be queued to disk during this past of the loop. If StartTime is less than or equal to CurTime then REQ will be queued to disk at block 133 and then return to the start block 121 through block 139. Since the request which was just queued to disk was not seek optimized, block 139 will not update any state.

If none of these conditions are true then Process 120 moves control to block 138 where a new value of SlackTime is calculated and DREQ is updated with REQ. Block 138 in turn passes control to blocks 137 and 136 in order to perform another pass through the priority loop.

Accordingly, the above described slack time scheduling process is capable of dealing with resource contention issues that arise in different applications. For example, as described above, from time to time clients 16 aggressively prefetch data from the server application 32. This aggressive prefetching can result in resource contention wherein the service level manager 30 is constantly receiving requests at the highest level of priority. The slack time process 120 allows the service level manager 30 to insert requests of a lower priority within a set of scheduled requests at a higher priority, and still comply with the service level agreement for the higher levels of priority.

Returning now to FIG. 4, it can be seen that the embodiment depicted therein includes a service level manager 30 that is capable of responding to a request by processing the request and meta-data associated with that request to resolve a level of service for that request and to respond to that request according to the resolved level of service.

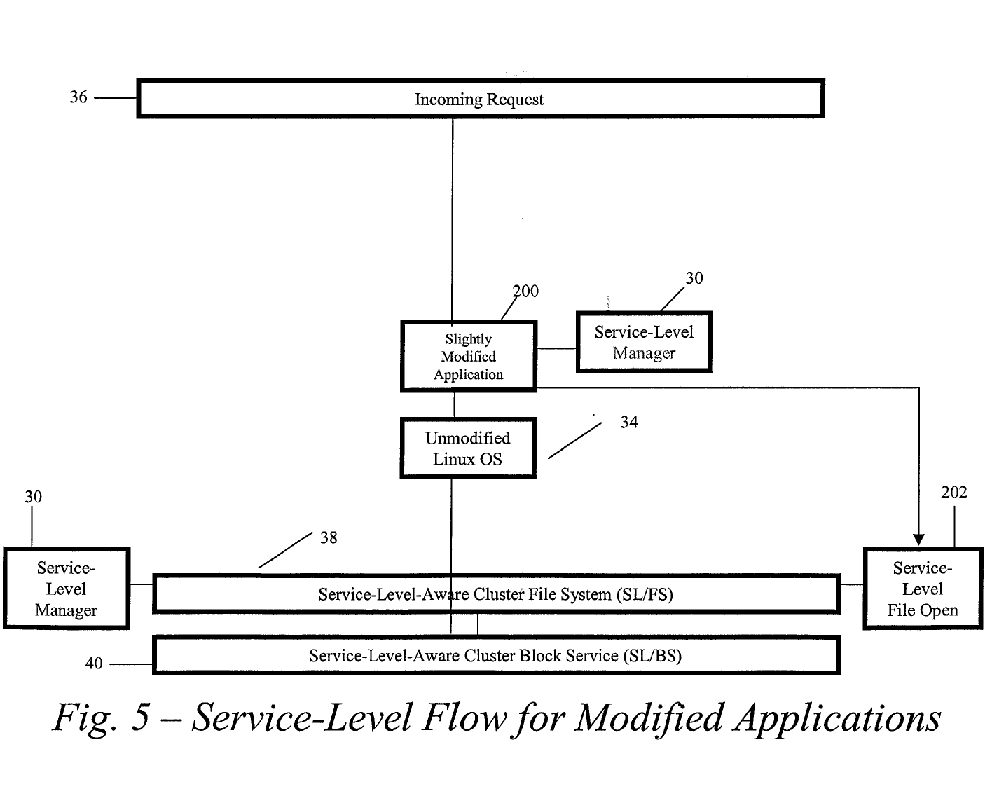

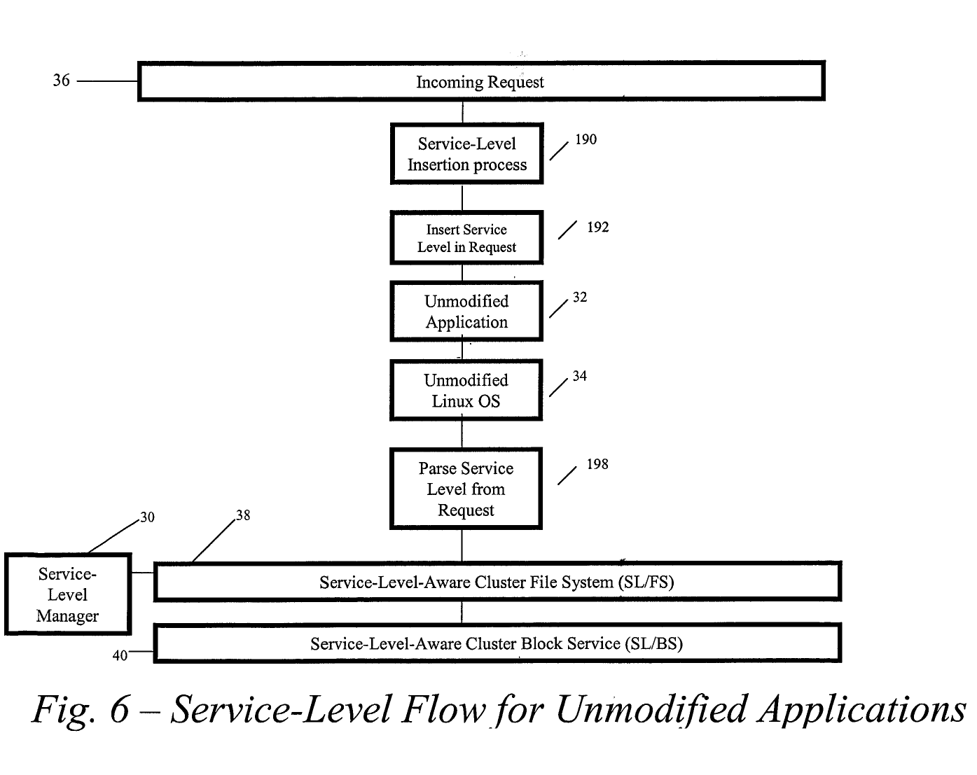

FIGS. 5 and 6 depict alternative embodiments of systems that are also capable of responding to a request by processing the request and associated meta-data to resolve a level of service for that request and to respond to that request according to the resolved level of service.

In particular, FIG. 5 depicts an embodiment of the system 20 that includes the an incoming request 36, a modified application 200, the operating system 34, the service level manager 30, the shared file system 38, and the block server 40. FIG. 5 depicts the embodiment of system 20 as having the service level manager 30 both in communication with the shared file system 38 and the modified application 200. In this embodiment the modified application 200 has been modified so that network-side information not normally passed through the file system 38 may be used to define the level of service for an incoming request. For example, in one embodiment the modified application 200 is a modified version of the Apache web server. As is known in the art, when the Apache web server receives a request, the Apache web server receives the HTTP header that comes with the request. The header information may include the type of client, such as the web browser, or media player, that comprises the client 16, it may also include the IP address for that client, information representative of whether the client is transferring information over a high speed, such as a DSL or cable network, and other network-side information. In the embodiment of FIG. 5, the modified application 200 calls the service level manager 30 and passes the service level manager 30 the network-side information. The service level manager 30 then returns a resolved service level to the modified application 200. The modified application 200 in turn calls the shared file system 38 with a file open request, depicted in FIG. 5 as element 202, a service level file open process, which establishes the correct service level context for managing the response.

In an alternative embodiment, the modified application 200 may call the service level manager 30 and pass the network-side information. In this alternative embodiment the service level manager 30 may access the content file requested by the client 16 and modify the service level information within the content file by adding additional information into the meta-data associated with that file. Optionally this may be done by the service level file open process 202. Returning to the discussion of Table 1, it can be seen that the meta-data associated with a content file may include multiple fields for receiving service level information including perhaps network-side service level information.

Once the network-side information is stored within the meta-data associated with the requested content file, the process may continue as described with reference with FIG. 4 and the service level manager 30 may employ the meta-data for scheduling and managing the requested response. Thus the service level manager 30 can process content related service level information and network-side information when determining a planned schedule for pending requests.

A further alternative embodiment is depicted in FIG. 6. Specifically, FIG. 6 depicts an embodiment wherein the service level manager 30 may include, or as depicted a separate process 190 may provide, functionality for inserting service level information within a received request 30. In one embodiment, the service level process 190 inserts that information within the URL of the requested content. As the URL may be employed as a pathname to the requested content file, the service level insertion process 190 may process network-side information, such as HTTP header information, to generate a pathname with network side information. The new pathname with inserted network side information can pass through the unmodified application 32 and the unmodified operating system 34 to the parsing service 198. In the depicted embodiment, the parsing service 198 is shown as separate from the operating system 34, but in other embodiments the parsing service 198 may be part of the operating system 34, or called by the operating system 34 or similarly the parsing service 198 may be part of the file system 38 or called by the file system 38. By integrating the parsing service 198 into the file system 38 or the operating system 34, the system 20 may more readily employ unmodified applications and still handle network side information. In any case, the pathname can pass through the application 32 and the operating system 34 and the information contained in that pathname may be sent to the service level manager 30. The service level manager 30 may resolve the information to determine what level of service to provide the request. The determined level of service may include a determination to admit the request and service it at a specific level of service, or to reject or redirect the request. One embodiment of a process for resolving the level of service is described with reference to FIGS. 13 and 14.

In one alternative embodiment, the modified URL may be employed as a pathname by the file system 38. The pathname identifies a particular file stored in a particular directory, and the particular file identified may include meta-data, such as a content group ID attribute, application group ID and requester group ID, that specifies a particular level or levels of service for the request. Thus, the directory and file selected by the file system 38 varies according to the information inserted into the pathname. In these embodiments the content data files may store all or at least a portion of the attributes that define the level of service to provide the request. Moreover, the different directories can store content data files that contain the same data but that have meta-data that varies depending upon the directory in which the content file is stored. Thus the same content may be stored in multiple different directories, but the meta-data of that file may vary. The depicted service level manager 30 collects both the content based service level information as well as the network based service level information and, as described with reference to FIGS. 7 through 9, manages the request according to the appropriate level of service.

Returning to FIG. 2, it can be seen that the system 20 further includes a block server 40. The depicted block server 40 is shared across the different disks 42 of the node. The block server can respond to requests from the shared file system 38 to read data blocks from the disks 42. These blocks are read in accordance with the service-level derived schedule.

The depicted data storage devices 42 may be any suitable devices including any suitable persistent data memory, such as a hard disk drive, RAID system, tape drive system, floppy diskette, or any other suitable system. The system depicted in FIG. 2 depicts the devices 42 as part of the server box, however it will be understood by those of ordinary skill in the art that in other embodiments the devices 42 can be separate from the server box and may optionally include networked devices and database systems. The type of data storage device employed, the integration of networked devices and the addition of database systems follow from techniques known in the art, and such modifications and adaptations will not depart from the scope of the invention.

Larger Cluster

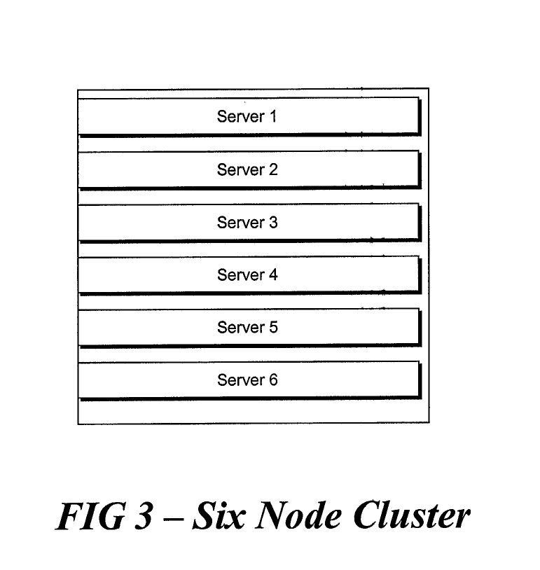

As discussed above, the system of FIG. 2 depicts the cluster as including two nodes, node 22 and node 24. However, as shown by FIG. 3 the cluster that forms the edge server 20 may be scaled according to the application and therefore may comprise any number of nodes. To this end, FIG. 3 depicts the cluster 20 as comprising six nodes. The number of nodes employed in any particular application will depend in part upon the workload being supported by the edge server 20. Those of ordinary skill in the art will know how to configure and arrange the nodes to support the workload required by the application of interest.

Graphical User Interface for Managing Service Levels

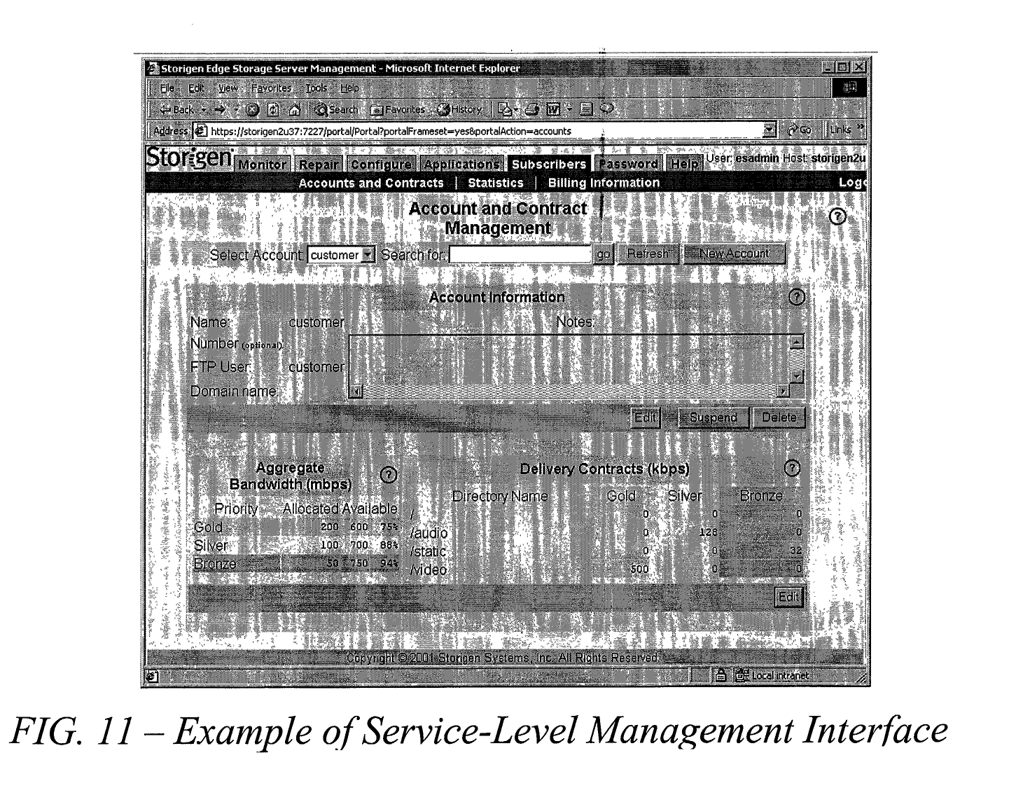

FIG. 11 presents a screen shot representative of the type of input screen that may be presented to an account holder. Such an account holder would have an account on the server 20. The account holder could store information or content on the server 20. That content may include video information, audio information or static content. As shown in FIG. 11 the account holder can select from different categories of service classes. Depicted in FIG. 11 are three service classes, the GOLD class, the SILVER class, and the BRONZE class. As shown in FIG. 11, the present account (called “Customer”) is configured for the GOLD, SILVER and BRONZE class to provide total bandwidths of 200, 100, and 50 Mbps respectively. These total bandwidths are available to serve content from the three directories shown on the right of the screen: audio, video, and static. This screen shows the association between these directories and certain service level parameters. For example, this system would serve all content from the video directory with GOLD priority at a bit rate of 500 Kbps. The screen shot depicted shows that the account information may be presented in an HTML form that may be edited by the user for changing the level of service the user wishes. The form may be used by a subscriber to add or change the service contracted.

Directory Hierarchy and Association with Service Levels

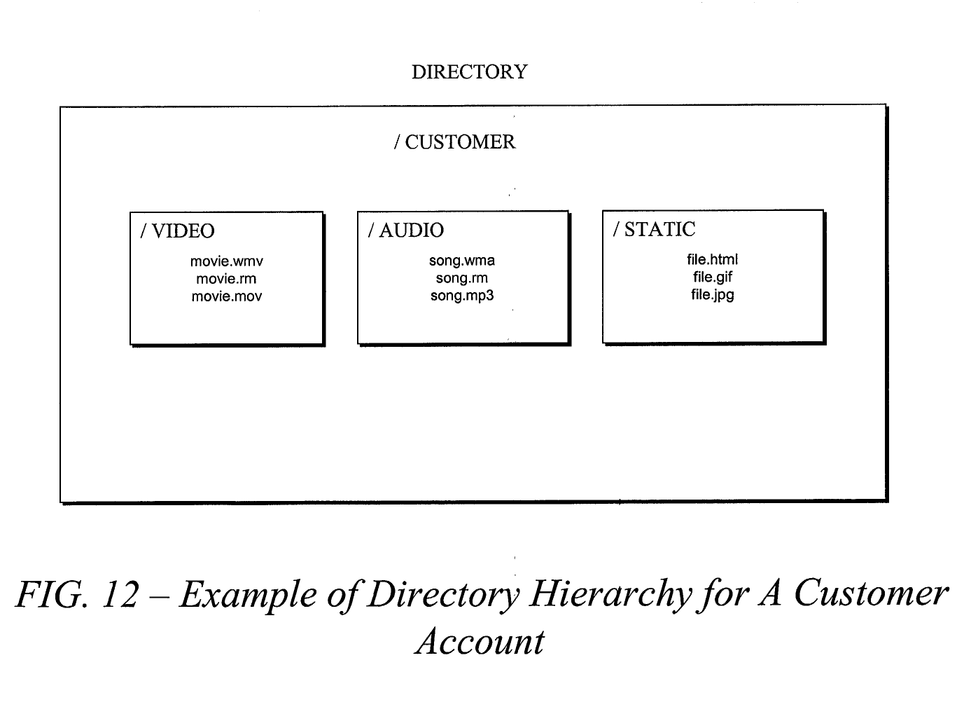

FIG. 12 provides a more detailed view into the directory structure shown in FIG. 11. For this account (“Customer”) a directory organization is created that includes a parent directory called customer with three subdirectories: video, audio, and static. As shown in FIG. 12 the video subdirectory may contain Real media files, Windows media files, Quick Time files, MPEG2 and MPEG4 files and other such video, audio and media data files. The audio subdirectory may contain MP3 files and the static subdirectory may contain HTML content or any other type of typical static data. The user may upload, typically by using an FTP process content files to the different directory structures. Once uploaded the information will be available to the server 20 for delivering to customers. Optionally, the system may provide the user with an HTML form that allows the user to define or set certain levels of service for each content file of the user. Similarly, level of service information may be added by a user to establish levels of service for individual requestors or groups of requesters. Other attributes may also be defined and used for establishing characteristics that may determine a service level for an incoming request.

Resolving a Response Service Level from Multiple Attributes

FIG. 13 describes a process that considers content, requestor and application attributes when determining the appropriate level of service for supporting a request.

Accordingly, the systems and methods described herein can resolve incoming requests to a level of service, and can do so even when the incoming request is associated with multiple levels of service that need to be considered. FIG. 13 depicts broadly one example of a process for resolving an incoming request to a level of service.

Specifically, FIG. 13 depicts a process 210 that begins with the block 212 where the information relevant to the assignment of service level is gathered. In process 212, the information gathered includes the attributes for the request. These attributes, as discussed above, may include an attribute associated with the requested content, and attribute associated with the requestor and an attribute associated with the application that will support the request. These attributes are examples of types of attributes or factors that the system 20 may employ when providing for different levels of service. However, these attributes are only examples and other attributes may be employed, including attributes such as the time of day, the number of times the file has been requested, the available network resources, and any other attribute that may be employed to define or establish different levels of service.

As shown in FIG. 13, once the attribute information is obtained, the process 200 may employ the attributes to generate inputs for the service level resolver process. These inputs for this example include group ID (GID) values for the content, requester and application. The group ID may be derived from a table associating a set of users to an RGID.

Once the inputs are generated, the process 200 proceeds to operation 214 wherein the inputs are applied to the service level tables (FIG. 15) and resolved into a set of service level options. Each service level option represents a level of service that may be provided to support the request. To this end the table depicted in FIG. 15 presents for a given GID information that is representative of the characteristics of a particular level of service. The table structure depicted in FIG. 15 is generic to any of the attributes; content, requestor and application.

Service Level Table Structure

For example, FIG. 15 depicts that an attribute (content, application, requester) that is associated with the group ID 001 and which has a priority of GOLD may be associated with an aggregate bandwidth of 100 Mbps, and an individual response bit rate of 1.00 Kbps wherein the bit rate control is set to be the minimum allowed bit rate and wherein an “no admission” determination made by the service level manager 30 results in the request being redirected to the URL http://redirect1.comSimilarly, an attribute associated with the group ID 001 and having a priority of SILVER may be associated with an aggregate bandwidth of 100 Mbps, and individual response bit rate of 0.500 Kbps wherein the bit rate control is set as the minimum and where a no admission determination by the service level manager 30 results in the request being rejected by the system.

Information required to associate Network Quality of Service technology (such as DIFFSRV or MPLS) with requests may be stored in this table. By including support for network QoS this service level table can provide end-to-end service level control. Without network QoS, the service level table provides control from disk drive to the server network port.

FIG. 15 illustrates that a separate table may be provided for each of the attribute analyzed by the system. Accordingly, any request may be associated with multiple different service levels, where one service level may arise from the particular content requested, another service level may arise from the requestor issuing the request, and a third service level may arise from the application being employed to service that request. As shown in process 210 these different service level options may be provided in block 218 to a process that resolves the different service level options to the most appropriate available service level based on the committed capacity of the system.

Service-Level Resolver

FIG. 14 illustrates that the service level resolver process can receive the content group ID, the requestor group ID and the application group ID. As discussed above this information may be employed to determine from the service level tables for the application, requestor or content a set of service level options that may be considered. These options may then be tested against the committed load including the application committed load, the requestor committed load, the content committed load, and the system committed load, to determine which option is available at a particular time. In the depicted embodiment, the best available service level is selected, but in other embodiments a different option may be selected. But for this embodiment, the final result is a fully resolved “best available” service level associated with the response. The fully resolved service level is then delivered from the service level resolver process for use by the system in scheduling and supporting the delivery of the content at the resolved level of service.

As shown in FIG. 14 the service level process can access information about the application committed load, requestor committed load, and content committed load, as well as the system committed load. The application, requestor and content committed load is information that may represent the load that is currently being applied by the application, requestor or content group respectively. The system committed load may represent the hard upper-bound of available system resources.

In one embodiment, the resolution of service level options for each attribute may be resolved to a single set of options by applying a precedence protocol on a parameter by parameter basis. FIG. 16 depicts one type of protocol or priority assignment example. Specifically FIG. 16 depicts a table wherein a priority number is attributed to each service level attribute and color based priority combination. Accordingly, in this example priority assignment a priority number of 10 is assigned to the attribute-color combination of application-gold. Similarly, a priority number 9 is assigned to the attribute-color combination requestor-gold. In this case the priority as set forth is such that priority 10 is the highest priority and 1 the lowest priority. The table of FIG. 16 provides the service level resolver process with a set of precedence rules that may be employed for selecting among, or combining, the different service level options. Importantly, it will be understood that the table depicted in FIG. 16 is merely one example of the order of precedence that may be set and that other orders of precedence may also be set. Similarly it will be further understood that the use of the precedence table such as that depicted in FIG. 16 is only one example or embodiment of the systems described herein and that other systems of the invention may be achieved wherein the service level resolver process employs a different process for resolving the service level. For example the service level resolver process may employ other types of rule based systems including rule based systems that take into consideration the past history of scheduled requests to determine new requests that are to be scheduled. Additional modifications and additions may include techniques that vary the precedence for purposes of providing service to requests of lower priority from time to time. Other techniques may be employed with the systems described herein without departing from the scope of the invention.

Service Level Resolver Examples

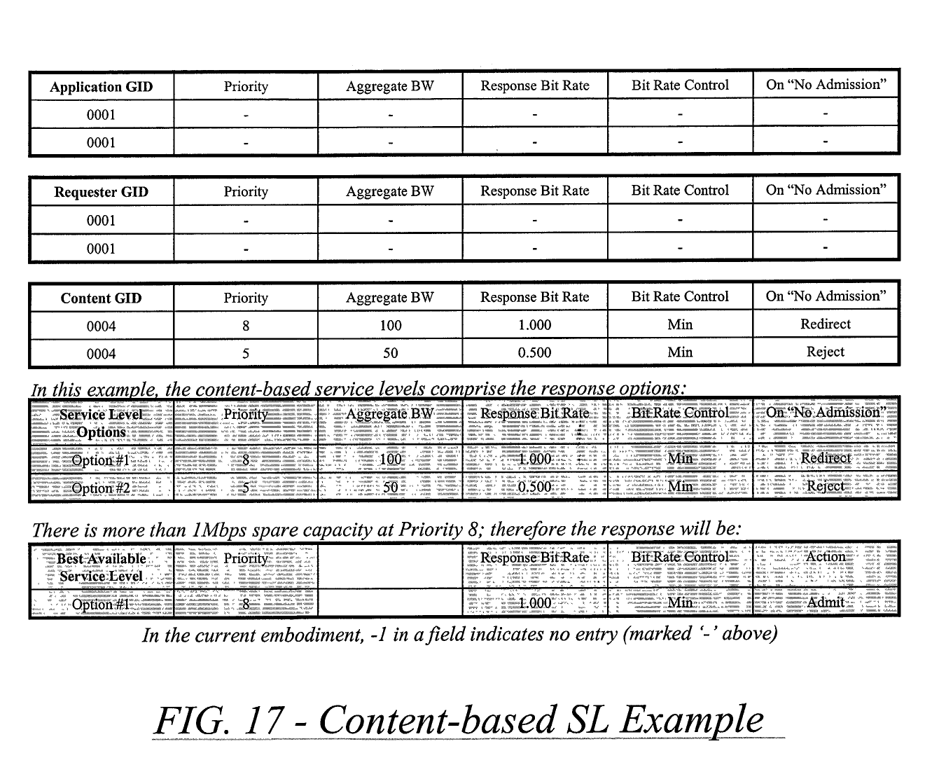

FIGS. 17 through 21 present examples of how a request may be resolved by the system to determine the proper service level to provide to the content associated with that request. Turning to FIG. 17 an example of a content-based service level determination is made. Specifically FIG. 17 depicts an example wherein a request for content is received by the system and the system determines that for the application, requestor and content group ID only the content attribute has service level information associated with it. Thus, in this example the incoming request would have a requestor group ID and application group ID of 0001 and this group ID would not be associated with any service level information. In contrast, the incoming request would have a content group ID of 0004. In the example of FIG. 17 this content group ID has two service levels associated with it. The first service level is given a priority of 8, the second a priority of 5. With reference to FIG. 16, it can be seen that priority number 8 is associated with content at the GOLD service level. Similarly, the priority number 5 is associated with the SILVER service level. The GOLD priority 8 has an aggregate bandwidth of 100 Mbps, a response bit rate of 1.00 Kbps the bit rate control is set at minimum and on the determination of “no admission” the request is redirected to another system. The SILVER priority level 5 is associated with a smaller aggregate bandwidth and a smaller response bit rate. Moreover, on a determination of “no admission”, the system rejects the requests and does not try to redirect to an alternate system that may have available capacity.

FIG. 17 depicts that the service level resolver process can employ the content group ID, requestor group ID and application group ID to collect service level information from the content service level table, requestor service level table and application service level table respectively. In this example, only the content group ID leads to an entry within a service level table, the content service level table, that contains service level information and in this case has two service level options. A service level resolver process may then compare the service level associated with these two options to the content committed load information to determine whether there is spare capacity. If there is then the request may be serviced at priority 8 and the fully resolved service level response will be, as shown as FIG. 17, the selection of option number 1, priority level 8, with a response bit rate of 1.000 Kbps, the bit rate control set at a minimum and the action being to admit the request to the current system.

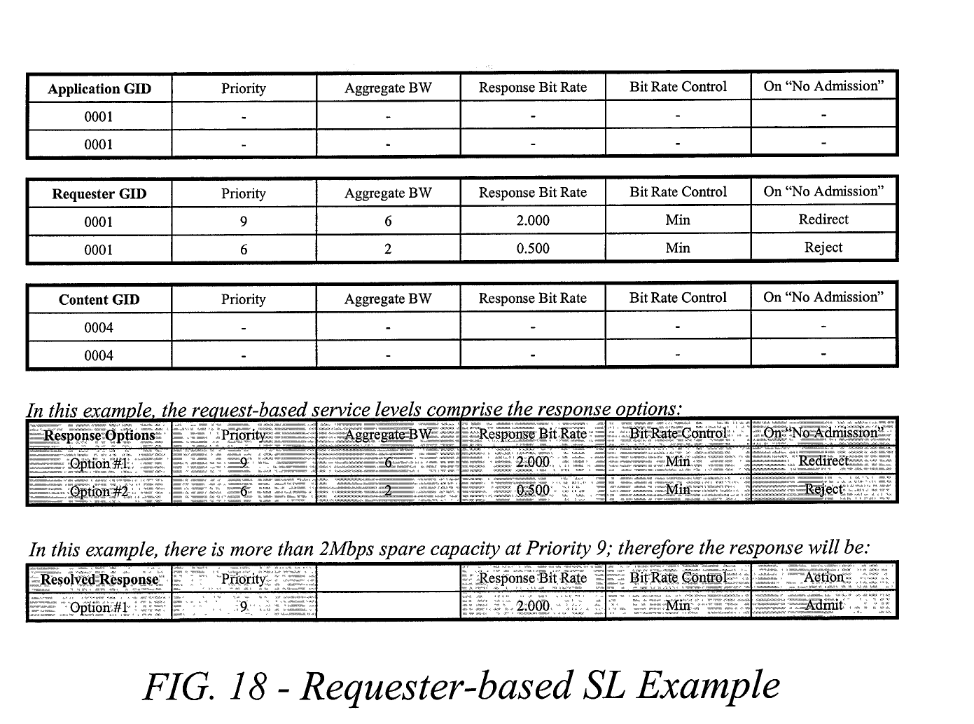

FIG. 18 depicts a similar type of operation, but in this case the incoming requests received by the system contains a content group ID, an application group ID that lacks service level option. However, the requestor group ID maps to two priorities, priorities 9 and 6. The color base priority associated with these priority numbers 9 and 6 may again be determined by reference to FIG. 16. In this case priority 9 is associated with the requestor attribute and the GOLD level of service. Priority 6 is again associated with the requestor attribute and in this case the SILVER level of service. Thus, the example of FIG. 18 yields request-based service levels that comprise the response options of option 1 which includes priority 9 and aggregate bandwidth of 6 Mbps, a response bit rate of 2.000 Kbps with the bit rate control set to minimum and a redirection command if a “no admission” determination is made. As further shown in FIG. 18, option 2 comprises the priority of 6 with an aggregate bandwidth of 2 Mbps, a response rate of 0.5 Kbps and a bit rate control set at minimum with a rejection command a determination of “no admission.” In this example, the service-level resolver process will compare the available options to the requester committed load information. If there is more than 2 Mbps spare capacity at priority 9 then the fully resolved service level response will be option 1. Alternatively, if there is less than 2 Mbps but greater than 0.5, then option 2 may be the determination.

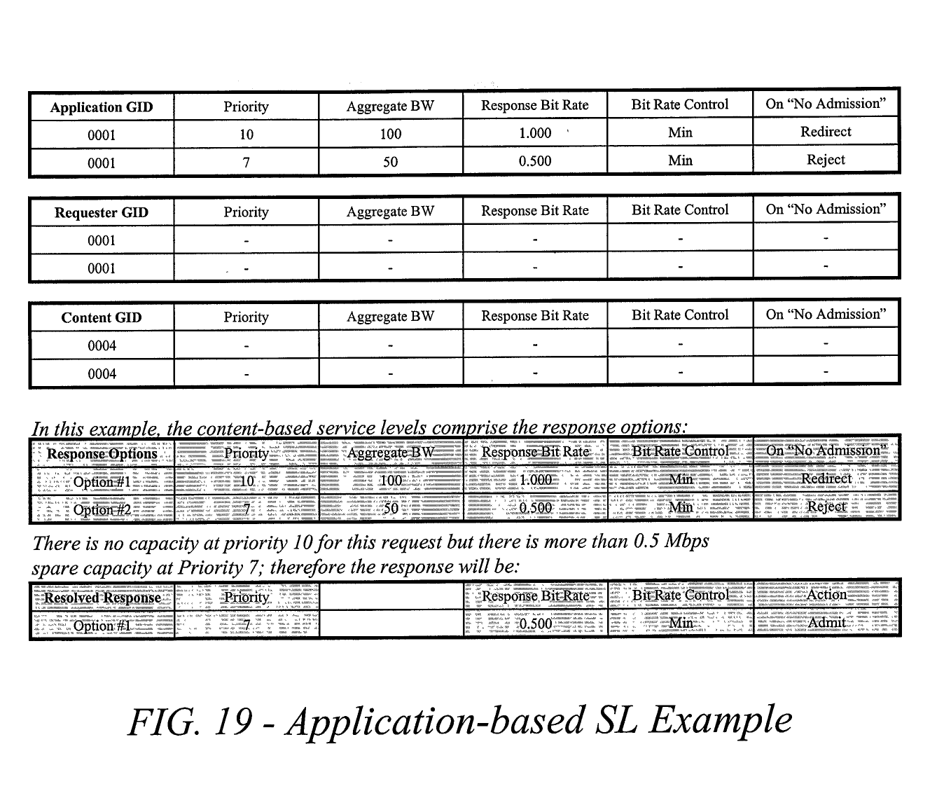

FIG. 19 provides a similar example. In this example, the application group ID yields two options, one at priority 10 and one at priority 7. Similar to the examples of FIGS. 17 and 18, by reviewing the priority assignment table of FIG. 16, the priority number 10 may be associated with the attribute color combination of application GOLD and the priority number 7 may be associated with the attribute color combination application SILVER. In this example, there are again two options, one at priority 10 and one at priority 7. For each option there is aggregate bandwidth, a response bit rate, a bit rate control and a “no admission” policy. With the two options available, the service level resolver may check the application committed load to determiner which of the options should be the fully resolved service level response. In the example presented by FIG. 19, there is insufficient capacity at priority 10 for this request but there is greater than 0.5 Mbps spare capacity at priority 7. Therefore the response may be option 1 priority 7.

Turning now to FIGS. 20 and 21, two examples are presented wherein an incoming request has service level information associated with two attributes. FIG. 20 is an example wherein both application and content based service level information is associated with the incoming request. FIG. 21 is an example where the incoming request has both requestor and content based service level information. For both of these examples of FIG. 1 and FIG. 21 the service level resolver must determine the options available and based on the available options determine the appropriate option for servicing the request.

FIG. 21 depicts one example of how the system resolves what level of service to provide to a received request for content that has a number of service levels associated with it. Specifically, the example set out in FIG. 21 illustrates the data that the process analyzes when determining the service level to provide to a request that has service level information associated with both the requestor and the content.

In this example, the system 20 would resolve a request from a requestor who has a purchased premium access service (offered by a network service provider) and when they access content that has its own set of defined service levels.

The request is received by the system and the requestor id is mapped to its corresponding Requestor Group ID; in this example 0001. There is one service level associated with RGID=0001 and it is:

Priority=9

Aggregate Bandwidth=1 Mbps

No other parameters are defined

The requested content is mapped to its corresponding Content Group ID; in this example 0004.

There are two service levels associated with CGID=0004 and they are:

Priority=8

Aggregate Bandwidth=100 Mbps

Response Bit Rate=1 Mbps

Bit Rate Control=Min

On “No Admission”=Redirect to www.redirect1.com

Priority=5

Aggregate Bandwidth=50 Mbps

Response Bit Rate=0.5 Mbps

Bit Rate Control=Min

On “No Admission”=Reject

Based on this information, the system 20 can determine there will be three service level options. The highest-priority option will be the composite of the requestor-derived service level (priority and aggregate bandwidth) combined with the content-derived service level which is closest in priority. In this case, the request-derived service level is:

Option #1:

Priority=9

Aggregate Bandwidth=1 Mbps

Response Bit Rate=1 Mbps

Bit Rate Control=Min

On “No Admission”=Redirect to www.redirect1.com

The next two options are the two content-derived service levels:

Option #2:

Priority=8

Aggregate Bandwidth=100 Mbps

Response Bit Rate=1 Mbps

Bit Rate Control=Min

On “No Admission”=Redirect to www.redirect1.com

Option #3:

Priority=5

Aggregate Bandwidth=50 Mbps

Response Bit Rate=0.5 Mbps

Bit Rate Control=Min

On “No Admission”=Reject

Thus there are three service level options and the system 20 needs to examine the committed load values to determine the “best-available” service level. A committed load value is the current value of committed bandwidth (sum of all response bit rates) for a given service level.

For purposes of this example, the following conditions apply:

Committed Load for RGID 0001 at Priority 9=1 Mbps

Committed Load for CGID 0004 at Priority 8=99 Mbps

Committed Load for CGID 0004 at Priority 5=25 Mbps

Based on these committed loads, the system 20 determines which options are available by comparing the Response Bit Rate with the available bandwidth. An option is available if the Response Bit Rate is greater than or equal to the Available Bandwidth. Available Bandwidth is equal to Aggregate Bandwidth (the maximum for this service level) minus Committed Load (the current load being served at this service level).

Option #1: Not available

Response Bit Rate>=Aggregate Bandwidth−Committed Load

1>=1−1

Option #2: Available

Response Bit Rate>=Aggregate Bandwidth−Committed Load

1>=100−99

Option #3: Available

Response Bit Rate>Aggregate Bandwidth−Committed Load

0.5>=50−25

Two options are available and this embodiment selects the available option with the highest priority. Thus, this response will be handled with Option 2 which is a service level of:

Option #2:

Priority=8

Aggregate Bandwidth=100 Mbps

Response Bit Rate=1 Mbps

Bit Rate Control=Min

On “No Admission”=Redirect to www.redirect1.com

The last operation is updating the committed load table. The committed load for CGID 0004 at Priority 8 will increased by 1 Mbps to reflect the acceptance of this response.

The depicted server 20 may be a dedicated server system having a data processor, such as an Intel based processor running the Linux operating system, and a plurality of disk drives. Optionally, the server can also be realized as a commercially available data processing platform such as an IBM PC-compatible computer running the Windows operating systems, or a SUN workstation running a Unix operating system, that has been programmed to operate as a system according to the invention.

Mixed Service Level Workload

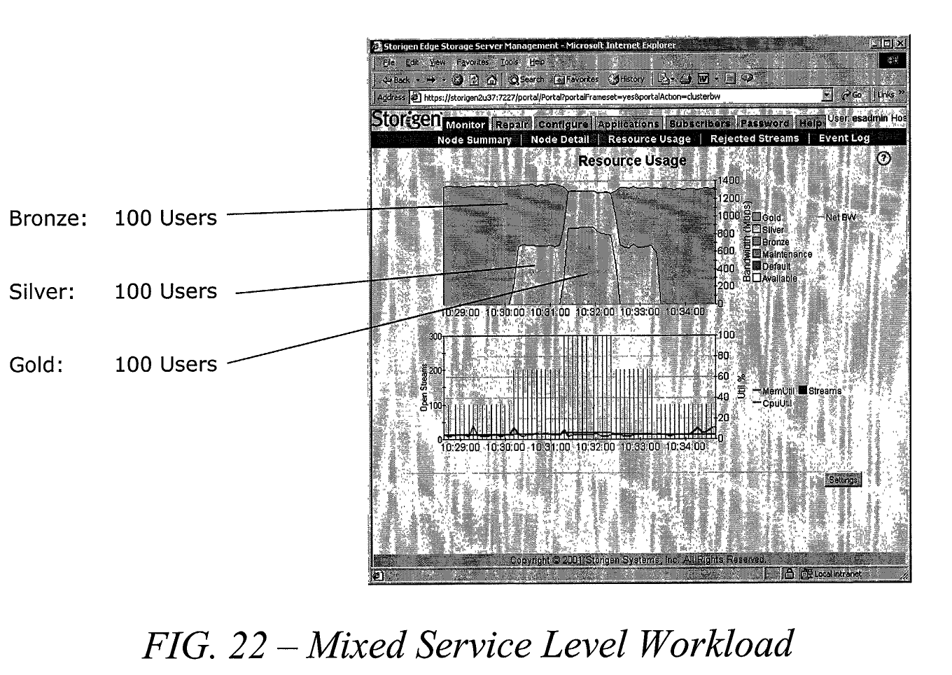

The performance of a dedicated server system having two Intel data processors, the Linux 2.4 Operating System, and eight Seagate 73GB SCSI disk drives running a mixed service level workload is shown in FIG. 22. This workload models multiple users file accessing content which has been assigned the GOLD, SILVER, and BRONZE service level priorities. Only content-based service level control is active in this workload. At the start of the test, 100 users, all accessing content with bronze class of service, 2 Mbps per stream bit rate and MIN bit rate control have been active for a extended period of time. The system is providing an aggregate bandwidth of about 1300 Mbps or about 13 Mbps per stream; well above the minimum defined by the service level. BRONZE is the lowest priority service in this test and represents a service-level which would be given to the lowest class of customers. Essentially this class of service is allowed to “soak” up any spare time left over after meeting the needs of higher priority users.

Just after time 10:30, 100 users start accessing content which has been assigned the SILVER class of service (one notch up from BRONZE) with a per stream bit rate of 2 Mbps and MIN bit rate control. As expected, the aggregate bandwidth consumed by the users accessing BRONZE content immediately drops to make room for the users accessing SILVER content. At this time, the system has sufficient bandwidth to meet the per stream bandwidth of SILVER (100×2 Mbps=200 Mbps) and BRONZE content. This system is running a disk scheduler at each of the eight disk drives as represented by process 120 described in FIG. 10. In this case, this scheduler algorithm automatically splits the available bandwidth between all the users with the result that BRONZE and SILVER users are each being served an aggregate bandwidth of about 650 Mbps.

Just after 10:31, 100 users start accessing content with GOLD priority, 7 Mbps per stream bit rate and MIN bit rate control. The distributed disk schedulers immediate respond by making room for the new high priority users by taking bandwidth away from lower priority users until the service level can be met for the all higher priority work. In this case, the schedulers determine that BRONZE priority can no longer be served at this time. SILVER service is reduced until the GOLD service meets its minimum service level of 100×7 Mbps=700 Mbps. All this reallocation has occurred over a very short period of time (approximately the time for 1-2 disk I/Os to complete or about 5-50 ms). This level of responsiveness is critical for a mixed class of service workload which includes real-time applications such as streaming media.

At about time 10:32:30, the GOLD users disconnect and the system automatically reallocates the available bandwidth to match the mix that existed prior to the time the GOLD users connected. Note that BRONZE access starts immediately after the GOLD users disconnect. This is because the system was just deferring the action of sending data to the BRONZE users while the GOLD users were connected but it did maintain “connections” to the BRONZE users. As described in process 50 block 62 (FIG. 7) the system would have terminated the BRONZE connections if it required resources used by these users. Deferring disk I/O operations typically does not require significant resources. At about time 10:33:30 the SILVER users disconnect and the BRONZE users are back to an aggregate bandwidth of 1300 Mbps.

Thus, although the above figures graphically depicts the elements of the server 20 as functional block elements, it will be apparent to one of ordinary skill in the art that these elements can be realized as computer programs or portions of computer programs that are capable of running on the data processor platform to thereby configure the data processor as a system according to the invention. The software can be implemented as a C language computer program, or a computer program written in any high level language including C++, Fortran, Java or Basic. Additionally, in optional embodiments where microcontrollers or DSPs are employed, the elements of the server 20 can be realized as computer programs written in microcode or written in a high level language and compiled down to microcode that can be executed on the platform employed. General techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. Accordingly, it will be understood that the invention is not to be limited to the embodiments disclosed herein, but is to be interpreted as broadly as allowed under the law.

1. A system for delivering content over a data network, comprising
a data storage device for storing content to be delivered over the data network,
a server process capable of monitoring the data network for responding to a request to serve selected content over the data network, and
a file system capable of communicating with the server process and capable of processing the request to identify meta-data associated with the selected content and being representative of a level of service to be provided the selected content.

2. A system according to claim 1, further including a service level manager capable of determining, as a function of the meta-data, whether the selected content may be serviced in compliance with the associated level of service.

3. A system according to claim 1, wherein the server process includes a process for directing the request to the service level manager.

4. A system according to claim 3, wherein the service level manager includes a request analyzer process for analyzing the request to identify information associated with a level of service to provide the request.

5. A process according to claim 3, wherein the request analyzer process includes means for identifying information selected from the group consisting of user identification, user ISP identification, transmission throughput, client, and CDN server identification

6. A system according to claim 3, wherein the service level manager includes a process for directing the server process to employ a selected file open process for requesting the file system to access data associated with the selected content.

7. A system according to claim 1, wherein the server process includes a file open process that includes a plurality of file open methods for indicating to the file system information representative of the level of service to provide the request.

8. A system according to claim 1, wherein the file system includes a process for associating with a file open request information representative of a level of service to provide to content associated with that request.

9. A system according to claim 1, further including a service level manager disposed at the front end of the server process for processing the request to associate with the request a level of service to provide.

10. A system according to claim 9, wherein the service level manager includes a process for embedding into a pathname service level information to be associated with the selected content.

11. A system according to claim 10 wherein the embedding process embeds service level information into a URL.pathname.

12. A system according to claim 1, wherein the file system includes parsing means for parsing a pathname associated with the selected content to identify a level of service to provide to the requested content.

13. A system according to claim 1, wherein the file system includes a process for associating the selected content with one of a plurality of different service levels.

14. A system according to claim 1, further including a scheduling process for generating a schedule for servicing the requested content.

15. A system according to claim 14, further including an admission process, responsive to the scheduling process, for employing the schedule to determine whether the request for selected content can be accommodated at the level of service associated with the request.

16. A system according to claim 14, wherein the scheduling process determines a deadline parameter representative of a time constraint for processing the request

17. A system according to claim 16, wherein the scheduling process determines the deadline parameter as a function of a target bit-rate for serving the selected content.

18. A system according to claim 16, wherein the scheduling process includes a process for employing the deadline parameter to generate the schedule for servicing the request.

19. A system according to claim 1, further including a slack-time process for arbitrating between scheduling requirements of content having different priorities of service levels.

20. A system according to claim 1, further including a control process for managing a system resource for controlling a rate at which services are provided.

21. A system according to claim 20 wherein the control process manages a system resource selected from the group consisting of data storage, system memory, processor resources, and network throughput.

22. A method for serving streams of content at selected levels of service, comprising
listening on a data network for a request for a stream of selected content,
executing a process capable of identifying a file associated with the selected content and capable of identifying meta-data associated with the file and having information representative of one of a plurality of levels of service to provide a stream of the selected content, and
controlling access by a streaming server process to a system resource employed for processing the request as a function of the level of service associated with the selected content.

23. A method according to claim 22 wherein controlling access to a system resource includes controlling access to a system resource selected from the group consisting of processor time, system memory, disk access, network bandwidth, buffer space, and

24. A method according to claim 22 wherein controlling access includes selecting a priority for a thread processing the stream of selected content.
